(19) United States
(12) Patent Application Publication
(10) Pub. No.: US 2019/0130087 A1
(43) Pub. Date: May 2, 2019

(54) ELECTRONIC APPARATUS, CONTROL DEVICE, AND NON-TRANSITORY COMPUTER READABLE STORAGE MEDIUM

(71) Applicant: KYOCERA CORPORATION, Kyoto (JP)

(72) Inventors: Takahiro MORI, Yokohama-shi (JP); Hidetoshi Hachiya, Yokohama-shi (JP)

(21) Appl. No.: 16/168,623

(22) Filed: Oct. 23, 2018

(30) Foreign Application Priority Data
Oct. 26, 2017 (JP) 2017-207414

(51) Int. Cl. G06F 21/32; G06F 21/84; G06F 3/0488; H03K 17/96; G06F 3/041

(52) U.S. Cl. CPC G06F 21/32; G06F 21/84; G06F 2221/2149; H03K 17/96; G06F 3/0414; G06F 3/04883

(57) ABSTRACT

An electronic apparatus comprises a display surface, a fingerprint sensor, and at least one processor. The fingerprint sensor detects a fingerprint of a finger touching the display surface. The at least one processor controls a display of the display surface and performs a fingerprint authentication based on a fingerprint detection result in the fingerprint sensor. The at least one processor executes first processing if the display surface, which is in a non-display state, is touched with a first finger, the first processing comprising changing a state of the display surface to a display state and performing a first fingerprint authentication based on the fingerprint detection result corresponding to the first finger.

### CROSS-REFERENCE TO RELATED APPLICATION

The present application claims priority under 35 U.S.C. § 119 to Japanese Patent Application No. 2017-207414, filed on Oct. 26, 2017, entitled “ELECTRONIC APPARATUS, CONTROL DEVICE, CONTROL PROGRAM, AND METHOD OF OPERATING ELECTRONIC APPARATUS”. The content of which is incorporated by reference herein in its entirety.

### FIELD

Embodiments of the present disclosure relate to an electronic device.

### BACKGROUND

Various techniques relating to electronic apparatuses are proposed.

### SUMMARY

An electronic apparatus, a control device, a non-transitory computer readable storage medium, and a method of operating the electronic apparatus are disclosed. In one embodiment, an electronic apparatus comprises a display surface, a fingerprint sensor, and at least one processor. The fingerprint sensor detects a fingerprint of a finger touching the display surface. The at least one processor controls a display of the display surface and performs a fingerprint authentication based on a fingerprint detection result in the fingerprint sensor. The at least one processor executes first processing if the display surface, which is in a non-display state, is touched with a first finger, the first processing comprising changing a state of the display surface to a display state and performing a first fingerprint authentication based on the fingerprint detection result corresponding to the first finger.

In one embodiment, a control device controls the electronic apparatus. The electronic apparatus comprises the control device, a display surface and a fingerprint sensor detecting a fingerprint of a finger touching the display surface. The control device changes a state of the display surface to a display state and performs a fingerprint authentication based on a fingerprint detection result corresponding to a finger in the fingerprint sensor if the display surface, which is in a non-display state, is touched with the finger.

In one embodiment, a non-transitory computer readable storage medium stores a control program. The control program controls an electronic apparatus including a display surface and a fingerprint sensor detecting a fingerprint of a finger touching the display surface. The control program makes the electronic apparatus execute processing of changing a state of the display surface to a display state and performing a fingerprint authentication based on a fingerprint detection result corresponding to a finger in the fingerprint sensor if the display surface, which is in a non-display state, is touched with a finger.

In one embodiment, a method of operating an electronic apparatus is a method of operating an electronic apparatus including a display surface and a fingerprint sensor detecting a fingerprint of a finger touching the display surface. The method comprises changing a state of the display surface to a display state and performing a fingerprint authentication based on a fingerprint detection result corresponding to a finger in the fingerprint sensor if the display surface, which is in a non-display state, is touched with the finger.

### BRIEF DESCRIPTION OF THE DRAWINGS

FIG. 1 illustrates a perspective view showing one example of an external appearance of an electronic apparatus.

FIG. 2 illustrates a rear view showing one example of the external appearance of the electronic apparatus.

FIG. 3 illustrates a block diagram showing one example of a configuration of the electronic apparatus.

FIG. 4 illustrates a drawing showing one example of a fingerprint detection region.

FIG. 5 illustrates a drawing showing one example of the fingerprint detection region.

FIG. 6 illustrates a drawing showing one example of a display of the electronic apparatus.

FIG. 7 illustrates a drawing showing one example of a display of the electronic apparatus.

FIG. 8 illustrates a flow chart showing one example of an operation of the electronic apparatus.

FIG. 9 illustrates a drawing showing one example of an operation performed on the electronic apparatus.

FIG. 10 illustrates a drawing showing one example of the display of the electronic apparatus.

FIG. 11 illustrates a drawing showing one example of the display of the electronic apparatus.

FIG. 12 illustrates a flow chart showing one example of the operation of the electronic apparatus.

FIG. 13 illustrates a drawing showing one example of the display of the electronic apparatus.

FIG. 14 illustrates a drawing showing one example of the display of the electronic apparatus.

FIG. 15 illustrates a flow chart showing one example of the operation of the electronic apparatus.

FIG. 16 illustrates a drawing showing one example of the operation performed on the electronic apparatus.

FIG. 17 illustrates a drawing showing one example of the display of the electronic apparatus.

FIG. 18 illustrates a drawing showing one example of the display of the electronic apparatus.

FIG. 19 illustrates a drawing showing one example of the operation performed on the electronic apparatus.

FIG. 20 illustrates a drawing showing one example of the display of the electronic apparatus.

FIG. 21 illustrates a drawing showing one example of the operation performed on the electronic apparatus.

FIG. 22 illustrates a drawing showing one example of the display of the electronic apparatus.

FIG. 23 illustrates a drawing showing one example of the display of the electronic apparatus.

FIG. 24 illustrates a drawing showing one example of information stored in a storage.

FIG. 25 illustrates a flow chart showing one example of the operation of the electronic apparatus.

FIG. 26 illustrates a drawing showing one example of the display of the electronic apparatus.

FIG. 27 illustrates a drawing showing one example of the display of the electronic apparatus.

FIG. 28 illustrates a drawing showing one example of the display of the electronic apparatus.

FIG. 29 illustrates a flow chart showing one example of the operation of the electronic apparatus.

FIG. 30 illustrates a drawing showing one example of the operation performed on the electronic apparatus.

FIG. 31 illustrates a drawing showing one example of the display of the electronic apparatus.

### DESCRIPTION OF THE PREFERRED EMBODIMENTS

<One Example of External Appearance of Electronic Apparatus>

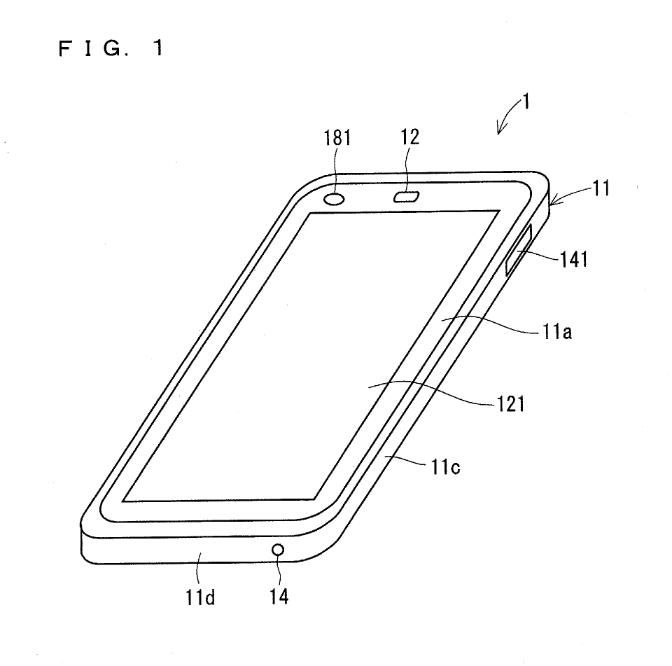

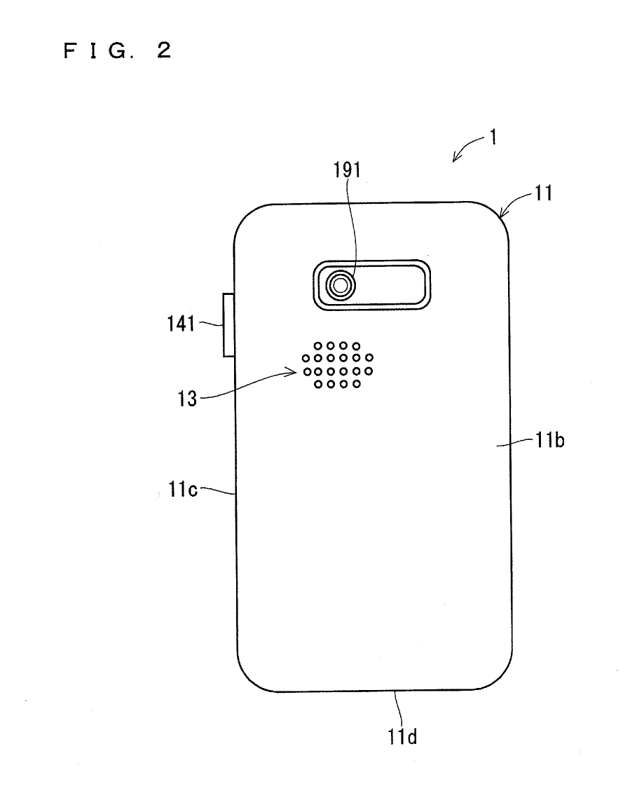

FIGS. 1 and 2 are a perspective view and a rear view showing an example of an external appearance of an electronic apparatus 1, respectively. As shown in FIGS. 1 and 2, the electronic apparatus 1 comprises an apparatus case 11 having a plate shape substantially rectangular in a plan view. The apparatus case 11 constitutes an exterior of the electronic apparatus 1.

A display surface 121, in which various types of information such as characters, symbols, and graphics are displayed, is located in a front surface 11a of the apparatus case 11, in other words, a front surface of the electronic apparatus 1. A touch panel 130, which will be described below, is located in a rear surface side of the display surface 121. Accordingly, a user can input various types of information to the electronic apparatus 1 by operating the display surface 121 in the front surface of the electronic apparatus 1 with his/her finger, for example. The user can also input the various types of information to the electronic apparatus 1 by operating the display surface 121 with a pen for the touch panel such as a stylus pen, for example, instead of an operator such as his/her finger. A location of the display surface 121 is not limited to an example in FIG. 1.

A receiver hole 12 is located in an upper end of the front surface 11a of the apparatus case 11. A microphone hole 14 is located in a side surface 11d in a lower side of the apparatus case 11. A lens 181 included in a first camera 180, which will be described below, can be visually recognized from the upper end of the front surface 11a of the apparatus case 11. As shown in FIG. 2, a lens 191 included in a second camera 190, which will be described below, can be visually recognized from a rear surface 11b of the apparatus case 11, in other words, the upper end of a rear surface of the electronic apparatus 1. A speaker hole 13 is located in the rear surface 11b of the apparatus case 11.

The electronic apparatus 1 includes an operation button group 140, which will be described below, including a plurality of operation buttons. Each operation button is a hardware button, for example, and is located in a surface of the apparatus case 11. Each of the plurality of operation buttons is a press button, for example. The operation button group 140 includes a power source button 141. The power source button 141 is located in a side surface 11c on a right side of the apparatus case 11. In the present specification, the right side means a right side in a case of viewing the display surface 121. A left side means a left side in the case of viewing the display surface 121. The operation button group 140 includes an operation button other than the power source button 141. For example, the operation button group 140 includes a volume button.

<One Example of Electrical Configuration of Electronic Apparatus>

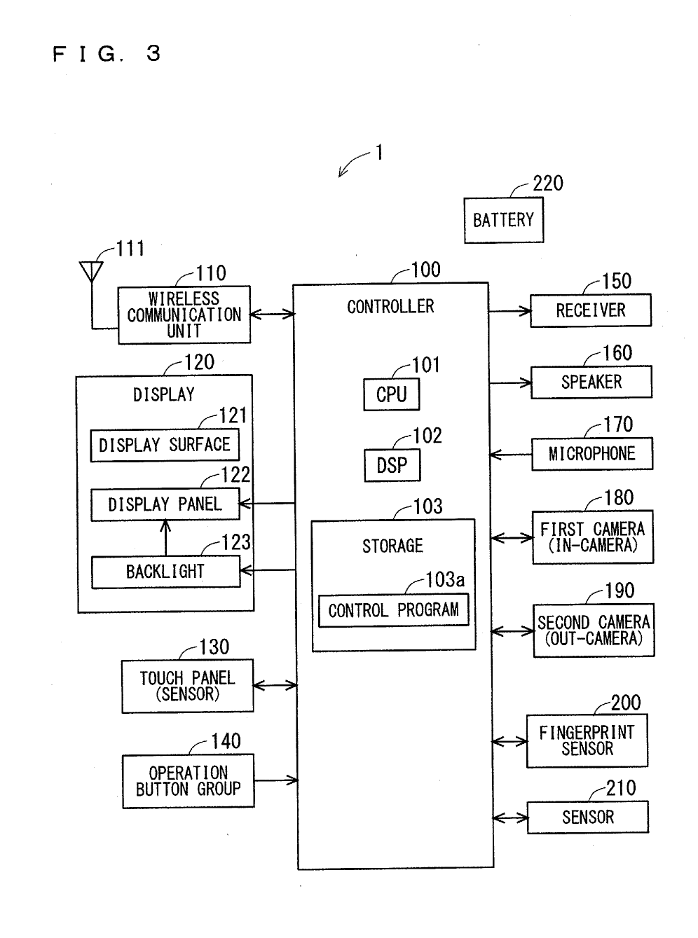

FIG. 3 is a block diagram mainly showing one example of an electrical configuration of the electronic apparatus 1. As shown in FIG. 3, the electronic apparatus 1 comprises a controller 100, a wireless communication unit 110, a display 120, the touch panel 130, and the operation button group 140. The electronic apparatus 1 further comprises a receiver 150, a speaker 160, a microphone 170, the first camera 180, the second camera 190, a fingerprint sensor 200, a sensor 210, and a battery 220. The apparatus case 11 houses these components included in the electronic apparatus 1.

The controller 100 controls the other components of the electronic apparatus 1 to be able to collectively manage the operation of the electronic apparatus 1. The controller 100 is also considered as a control device or a control circuit. The controller 100 includes at least one processor for providing control and processing capability to execute various functions as described in detail below.

In accordance with various embodiments, the at least one processor may be implemented as a single integrated circuit (IC) or as multiple communicatively coupled IC's and/or discrete circuits. The at least one processor can be executed in accordance with various known techniques.

In one embodiment, the processor includes one or more circuits or units configurable to perform one or more data computing procedures or processes by executing instructions stored in an associated memory, for example. In the other embodiment, the processor may be firmware configurable to perform one or more data computing procedures or processes (a discrete logic component, for example).

In accordance with various embodiments, the processor may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described hereinafter.

In the present example, the controller 100 comprises a central processing unit (CPU) 101, a digital signal processor (DSP) 102, and a storage 103. The storage 103 includes a non-transitory recording medium readable by the CPU 101 and the DSP 102 such as a read only memory (ROM) and a random access memory (RAM). The ROM of the storage 103 is, for example, a flash ROM (flash memory) that is a non-volatile memory. The storage 103 stores a plurality of control programs 103a to control the electronic apparatus 1. The CPU 101 and the DSP 102 execute the various control programs 103a in the storage 103 to achieve various functions of the controller 100.

The controller 100 may comprise a plurality of CPUs 101. In the above case, the controller 100 may comprise a main CPU having a high processing capacity to perform comparative complex processing and a sub CPU having a low processing capacity to perform comparative simple processing. It is also applicable that the controller 100 does not comprise the DSP 102 or comprises a plurality of DSPs 102. All or some of the functions of the controller 100 may be achieved by a hardware circuit that needs no software to achieve the functions above.

The storage 103 may comprise a non-transitory computer readable recording medium other than the ROM and the RAM. The storage 103 may comprise, for example, a compact hard disk drive and a solid state drive (SSD).

The plurality of control programs 103a in the storage 103 include various applications (that is to say, application programs). The storage 103 stores, for example, a call application to perform a voice call and a video call, a browser to display a website, and a mail application to create, browse, send, and receive an e-mail. The storage 103 also stores a camera application to take a picture of an object using the first camera 180 and the second camera 190, a recorded image display application to display a still image and a video recorded in the storage 103, and a music reproduction control application to control a reproduction of music data stored in the storage 103. The storage 103 may store at least one application in the storage 103 in advance. The electronic apparatus 1 may download the at least one application in the storage 103 from the other device and store it in the storage 103.

The wireless communication unit 110 includes an antenna 111. The wireless communication unit 110 can perform a wireless communication in several types of communication systems, for example, using the antenna 111. The controller 100 controls the wireless communication of the wireless communication unit 110.

The wireless communication unit 110 can perform a wireless communication with a base station of a mobile phone system. The wireless communication unit 110 can communicate with a mobile phone different from the electronic apparatus 1 or a web server via a network such as the base station or Internet. The electronic apparatus 1 can perform a data communication, a voice call and a video call with the other mobile phone, for example.

The electronic apparatus 1 can perform a wireless communication using the wireless communication unit 110 and a wireless local area network (LAN) such as WiFi. The wireless communication unit 110 can perform a near field wireless communication. For example, the wireless communication unit 110 can perform the wireless communication in conformity to Bluetooth (registered trademark). The wireless communication unit 110 may perform the wireless communication in conformity to at least one of ZigBee (registered trademark) and near field communication (NFC).

The wireless communication unit 110 can perform various types of processing such as amplification processing on a signal received by the antenna 111 and then outputs a resultant signal to the controller 100. The controller 100 can perform the various types of processing on the received signal which has been input, to obtain information contained in the received signal. The controller 100 outputs a transmission signal containing the information to the wireless communication unit 110. The wireless communication unit 110 can perform the various types of processing such as amplification processing on the transmission signal being has been input, and then wirelessly transmits a resultant signal from the antenna 111.

The display 120 comprises the display surface 121, a display panel 122, and a backlight 123 located in the front surface 11a of the electronic apparatus 1. The display 120 can display various types of information on the display surface 121. The display panel 122 is, for example, a liquid crystal display panel and comprises a plurality of pixels (also referred to as “a pixel unit” or “a pixel circuit”). The display panel 122 comprises a liquid crystal, a glass substrate, or a polarization plate, for example. The display panel 122 faces the display surface 121 in the apparatus case 11. The information displayed in the display 120 is displayed on the display surface 121 of the surface of the electronic apparatus 1. The backlight 123 emits light to the display panel 122 from a back side of the display panel 122. The backlight 123 comprises at least one light-emitting diode (LED), for example. The display panel 122 can control a transmission amount of light transmitted from the backlight 123 by pixel unit under control of the controller 100. The display panel 122 can thereby display the various types of information. When the controller 100 controls each pixel of the display panel 122 in a state where the backlight 123 is turned on, the display 120 can display the various types of information such as characters, signs, and graphics. The controller 100 can control the display of the display surface 121 by controlling the display panel 122. It is deemed that the controller 100 can display the information on the display surface 121 via the display panel 122. The controller 100 can control the backlight 123. The controller 100 can turn on and off the backlight 123, for example.

The display panel 122 may be a display panel other than the liquid crystal display panel. For example, the display panel 122 may be a self-luminous display panel such as an organic electroluminescence (EL) panel. The backlight 123 is not necessary in the above case.

The touch panel 130 can detect an operation performed on the display surface 121 with the operator such as the finger. The touch panel 130 is deemed to be a sensor detecting the operation performed on the display surface 121. The touch panel 130 is, for example, a projected capacitive touch panel. The touch panel 130 is located on a back side of the display surface 121, for example. When the user performs the operation on the display surface 121 with the operator such as his/her finger, the touch panel 130 can input, to the controller 100, an electrical signal in accordance with the operation. The controller 100 can specify contents of the operation performed on the display surface 121 based on an output signal being output from the touch panel 130. The controller 100 can perform the processing in accordance with the specified operation contents. An in-cell display panel in which a touch panel is incorporated may be adopted instead of the display panel 122 and the touch panel 130.

When the user operates each operation button of the operation button group 140, the operation button can output to the controller 100 an operation signal indicating that the operation button has been operated. The controller 100 can accordingly determine whether or not each operation button has been operated for each operation button. The controller 100 to which the operation signal is input controls the other component, thereby causing the electronic apparatus 1 to execute the function allocated to the operated operation button.

The microphone 170 can convert a sound from the outside of the electronic apparatus 1 into an electrical sound signal and then output the electrical sound signal to the controller 100. The sound from the outside of the electronic apparatus 1 is taken inside the electronic apparatus 1 through the microphone hole 14 and input to the microphone 170.

The speaker 160 is, for example, a dynamic speaker. The speaker 160 can convert an electrical sound signal from the controller 100 into a sound and then output the sound. The sound being output from the speaker 160 is output outside through the speaker hole 13. The user can hear the sound being output from the speaker hole 13 in a place apart from the electronic apparatus 1.

The receiver 150 can output a received sound. The receiver 150 is, for example, a dynamic speaker. The receiver 150 can convert an electrical sound signal from the controller 100 into a sound and then output the sound. The sound being output from the receiver 150 is output outside through the receiver hole 12. A volume of the sound being output through the receiver hole 12 is set to be smaller than a volume of the sound being output through the speaker hole 13. The user brings the receiver hole 12 close to his/her ear, thereby being able to hear the sound being output through the receiver hole 12. A vibration element such as a piezoelectric vibration element for causing a portion of the front surface of the apparatus case 11 to vibrate may be provided instead of the receiver 150. In the above case, the sound is transmitted to the user in a form of the vibration of the portion of the front surface.

The first camera 180 comprises the lens 181, an image sensor, and so on. The second camera 190 comprises the lens 191, an image sensor, and so on. Each of the first camera 180 and the second camera 190 can take an image of an object under control of the controller 100, generate a still image or a video of the object, and then output the still image or the video to the controller 100.

The lens 181 of the first camera 180 can be visually recognized from the front surface 11a of the apparatus case 11. Accordingly, the first camera 180 can take an image of an object located on a front surface side (in other words, the display surface 121 side) of the electronic apparatus 1. The first camera 180 is referred to as an in-camera. In the meanwhile, the lens 191 of the second camera 190 can be visually recognized from the rear surface 11b of the apparatus case 11. Accordingly, the second camera 190 can take an image of an object located on a rear surface side of the electronic apparatus 1. The second camera 190 is referred to as an out-camera.

The fingerprint sensor 200 can detect a fingerprint of the finger touching the display surface 121. Herein, the touch of the display surface 121 with the finger includes both a state where the finger is lightly attached to the display surface 121 and a state where the finger presses the display surface 121 (in other words, the finger pushes the display surface 121). Accordingly, the fingerprint sensor 200 can detect the fingerprint of the finger when the finger is lightly attached to the display surface 121. The fingerprint sensor 200 can detect the fingerprint of the finger when the finger presses the display surface 121. The fingerprint sensor 200 can detect the fingerprint of the finger in any of the cases where the finger presses the detection object surface 12 weakly or hard. The fingerprint sensor 200 can detect a fingerprint of the finger touching a fingerprint detection region 201 being set in the display surface 121.

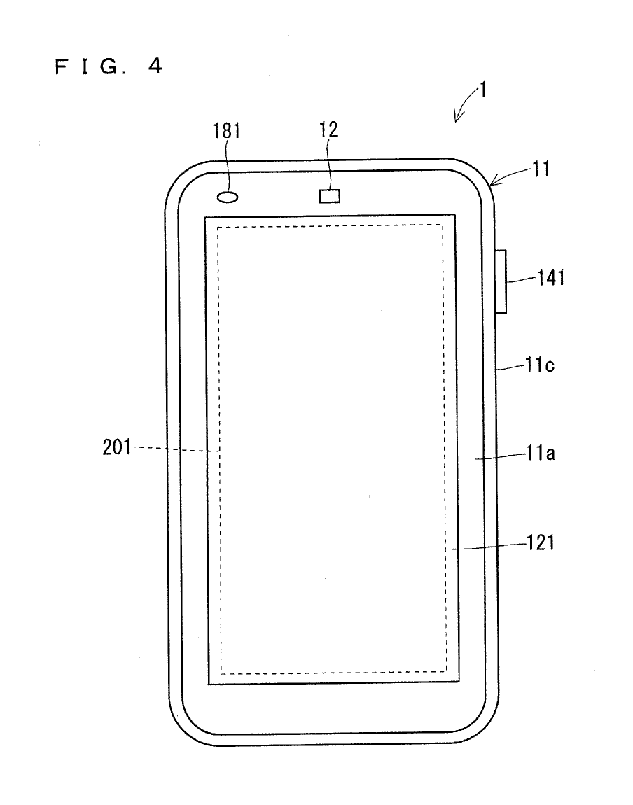

FIG. 4 is a drawing showing one example of the fingerprint detection region 201. As shown in FIG. 4, the fingerprint detection region 201 has a rectangular shape similar to a shape of the display surface 121, for example. A size of the fingerprint detection region 201 is substantially the same as that of the display surface 121, for example.

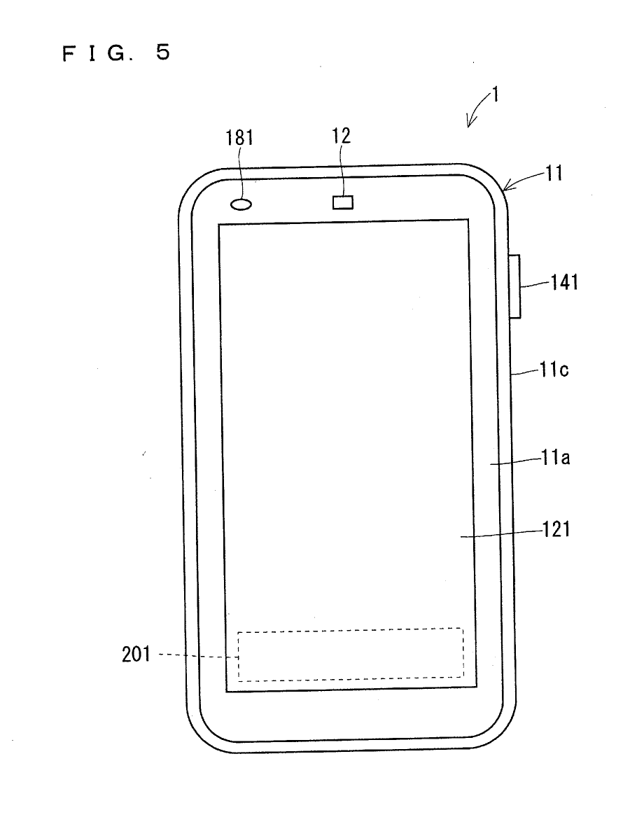

The size of the fingerprint detection region 201 may be the same as that of the display surface 121. As shown in FIG. 5, the fingerprint detection region 201 is located in an end portion of the display surface 121. In the example in FIG. 5, the fingerprint detection region 201 is located in a lower end portion of the display surface 121. The fingerprint detection region 201 may be located in an upper end portion, a right end portion, or a left end portion of the display surface 121. The fingerprint detection region 201 may be located on a lower half, an upper half, a right half, or a left half of the display surface 121. If the fingerprint detection region 201 includes a region on a lower side of the display surface 121 as shown in FIGS. 4 and 5, the user can easily touch the fingerprint detection region 201 with his/her finger. The fingerprint detection region 201 is simply referred to as “the detection region 201” in some cases hereinafter.

A fingerprint detection system in the fingerprint sensor 200 is, for example, a capacitance system. A system other than the capacitance system may also be adopted as the fingerprint detection system in the fingerprint sensor 200. For example, an optical system may be adopted as the fingerprint detection system in the fingerprint sensor 200. The fingerprint detected by the fingerprint sensor 200 is referred to as “the detected fingerprint” in some cases hereinafter.

The sensor 210 can detect a pressing force exerted by the finger on the display surface 121. The sensor 210 is, for example, a pressure sensor. The sensor 210 may be a piezoelectric sensor detecting an oscillation of the finger touching the display surface 121, for example. The finger of a person oscillates in accordance with an action of a muscle and a pulse, and a temporal change of the oscillation shows a characteristic pattern. When the finger presses a surface, the characteristic pattern in the temporal change of the oscillation of the finger changes in accordance with the pressing force of the finger. The piezoelectric sensor can detect the pressing force exerted by the finger on the display surface 121 by detecting the pattern in the temporal change of the oscillation of the finger touching the display surface 121. The controller 100 can specify whether the display surface 121 is touched by the finger of the person or touched by an object other than the finger of the person based on a detection value of the piezoelectric sensor.

The battery 220 can output a power source for the electronic apparatus 1. The battery 220 is, for example, a rechargeable battery. The battery 220 can supply the power source to various components such as the controller 100 and the wireless communication unit 110 included in the electronic apparatus 1.

The electronic apparatus 1 may comprise a sensor other than the touch panel 130, the fingerprint sensor 200, and the sensor 210. For example, the electronic apparatus 1 may comprise at least one of an acceleration sensor, an atmospheric pressure sensor, a geomagnetic sensor, a temperature sensor, a proximity sensor, an illuminance sensor, and a gyro sensor.

<One Example of Operation Mode of Electronic Apparatus>

The electronic apparatus 1 has a large number of operation modes. The operation modes of the electronic apparatus 1 include, for example, a normal mode, a sleep mode, and a shutdown mode. In the shutdown mode, the electronic apparatus 1 is shut down, and most functions of the electronic apparatus 1 are suspended. In the sleep mode, some functions of the electronic apparatus 1, including a display function, are suspended. Operating in the normal mode means that the electronic apparatus 1 operates in a mode other than the sleep mode and the shutdown mode. The controller 100 sets the operation mode of the electronic apparatus 1 by controlling predetermined components of the electronic apparatus 1 in accordance with the operation mode to be set.

In the sleep mode, for example, some components of the electronic apparatus 1, including the display panel 122, the backlight 123, the touch panel 130, the first camera 180, the second camera 190, and the fingerprint sensor 200 do not operate. In the shutdown mode, most components of the electronic apparatus 1, including the display panel 122, the backlight 123, the touch panel 130, the first camera 180, the second camera 190, the fingerprint sensor 200, and the sensor 210 do not operate. In the sleep mode, the electronic apparatus 1 consumes less power than in the normal mode. In the shutdown mode, the electronic apparatus 1 consumes less power than in the sleep mode.

In the sleep mode and in the shutdown mode, the display surface 121 is in a non-display state. Herein, a display state indicates a state where the electronic apparatus 1 purposely displays the information on the display surface 121. The non-display state indicates a state where the electronic apparatus 1 does not purposely display the information on the display surface 121. In the present example, when the backlight 123 is turned off, the electronic apparatus 1 cannot purposely display the information on the display surface 121. Accordingly, when the backlight 123 is turned off, the display surface 121 enters the non-display state. In other words, when the backlight 123 is not driven, the display surface 121 is in the non-display state. In a case where the display panel 122 is a self-luminous display panel such as an organic EL panel, when no pixel emits light, the display surface 121 is in the non-display state. That is to say, when the whole region in the display region of the display panel 122 is in the lighting-off state, the display surface 121 is in the non-display state.

If the power source button 141 is pressed for a long time in the normal mode, the display surface 121 displays a confirmation screen to confirm with the user about whether or not to make the operation mode transition from the normal mode to the shutdown mode. If the user performs a predetermined operation on the display surface 121 in a state where the display surface 121 displays the confirmation screen, the operation mode transitions from the normal mode to the shutdown mode.

If no operation is performed on the electronic apparatus 1 for a given period of time or more in the normal mode, the operation mode transitions from the normal mode to the sleep mode. The operation mode transitions from the normal mode to the sleep mode when the power source button 141 is pressed for a short time in the normal mode.

In the meanwhile, the operation mode transitions from the sleep mode to the normal mode when the power source button 141 is pressed for a short time in the sleep mode. That is to say, when the power source button 141 is pressed for a short time in the sleep mode, the functions suspended at transition to the sleep mode are restored in the electronic apparatus 1. The normal mode in the present example includes a lock mode which will be described hereinafter. The operation mode transitions from the sleep mode to the lock mode when the power source button 141 is pressed for a short time in the sleep mode. The operation mode transitions from the sleep mode to the normal mode when a predetermined operation is performed on the display surface 121 in the sleep mode. The operation mode simply means the operation mode of the electronic apparatus 1 hereinafter.

<One Example of Screen Displayed on Display Surface>

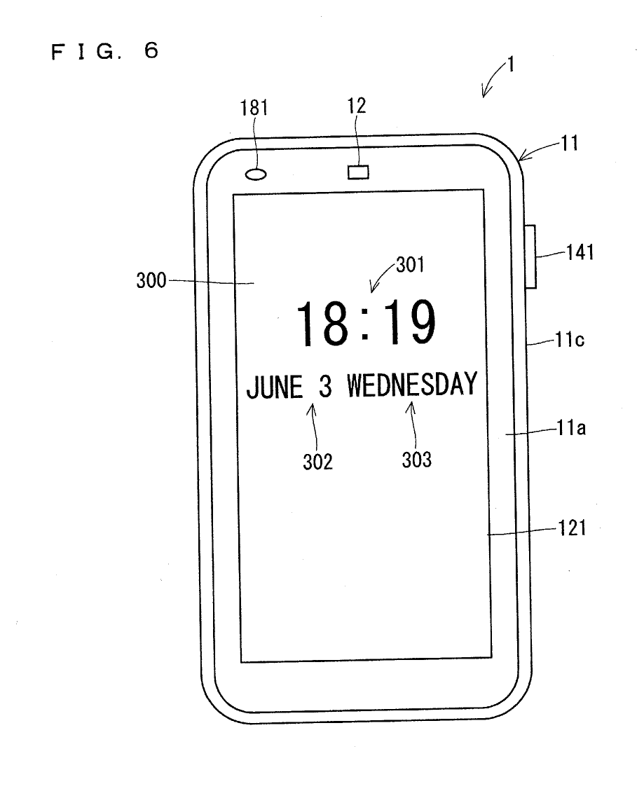

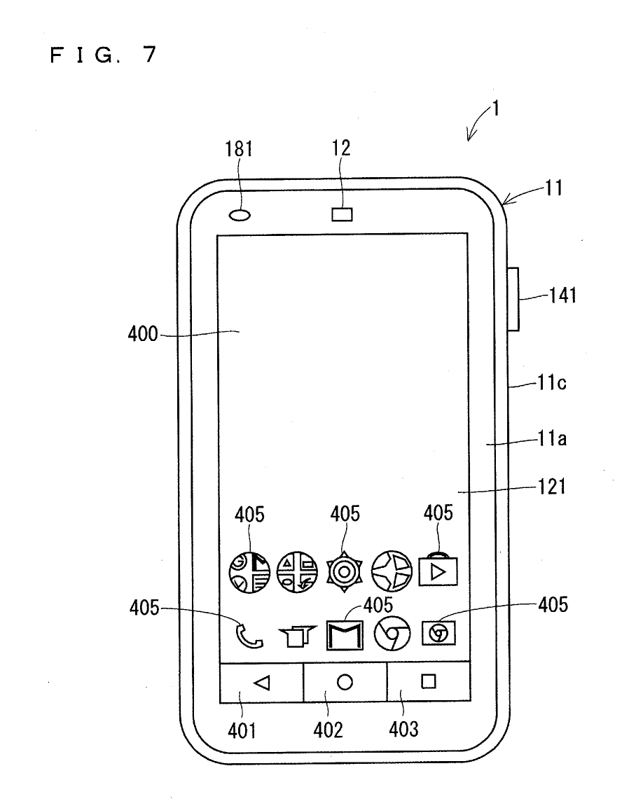

The display surface 121 displays various screens in the normal mode. The screen displayed on the display surface 121 is also deemed to be an image displayed on the display surface 121. The display surface 121 displays a home screen and a lock screen, for example. FIG. 6 is a drawing showing one example of a lock screen 300. FIG. 7 is a drawing showing one example of a home screen 400.

As shown in FIG. 6, the lock screen 300 indicates a current time 301, a current date 302, and a current day 303, for example.

The normal mode herein includes a lock mode in which the user cannot make the electronic apparatus 1 execute any applications other than specific applications (e.g., the call application and the camera application) of a plurality of applications stored in the storage 103. The lock mode is also referred to as the screen lock mode. In the lock mode, the user cannot instruct the electronic apparatus 1 to execute each of the applications other than the specific applications of the plurality of applications stored in the storage 103. The lock screen 300 is a screen indicating that the electronic apparatus 1 is in the lock mode, and is displayed on the display surface 121 when the operation mode is the lock mode. In the lock mode, it is not necessary for the user to be able to make the electronic apparatus 1 execute all the applications stored in the storage 103.

When the power source button 141 is pressed for a short time in the sleep mode, the sleep mode is canceled, and the operation mode of the electronic apparatus 1 transitions to the lock mode. The lock screen 300 is thus displayed on the display surface 121. When the user performs a predetermined operation on the electronic apparatus 1 during display of the lock screen 300 on the display surface 121, the lock mode of the electronic apparatus 1 is canceled, and the display on the display surface 121 transitions from the lock screen 300 to another screen, such as the home screen 400 (refer to FIG. 7), for example. A state where the lock mode has been canceled in the normal mode is also referred to as an “unlock mode” in some cases hereinafter.

The home screen 400 shows a plurality of operation buttons 401 to 403 as shown in FIG. 7. Each of the operation buttons 401 to 403 is a software button. The operation buttons 401 to 403 are also shown in a screen other than the home screen 400 in the unlock mode.

The operation button 401 is a back button, for example. The back button is an operation button for switching the display on the display surface 121 to the immediately preceding display. The user performs a predetermined operation on the operation button 401 to switch the display on the display surface 121 to the immediately preceding display. For example, the user performs a tap operation on the operation button 401 to switch the display on the display surface 121 to the immediately preceding display. The tap operation refers to an operation of taking the finger off a touch position on an operation object surface right after touching the operation object surface. The long tap operation described hereinafter refers to an operation of taking the finger off a touch position on an operation object surface some time after touching the operation object surface. The operation button 402 is a home button, for example. The home button is an operation button for displaying the home screen 400 on the display surface 121. When the user performs the tap operation on the operation button 402, for example, the display surface 121 displays the home screen. The operation button 403 is a history button, for example. The history button is an operation button to display a history of an application executed by the electronic apparatus 1 on the display surface 121. When the user performs the tap operation on the operation button 403, for example, the display surface 121 displays a history of the applications executed by the electronic apparatus 1.

The home screen 400 shows icons 405, corresponding to the applications in the storage 103, for instructing the electronic apparatus 1 to execute the corresponding applications. The icons 405 are also referred to as display objects. In the example in FIG. 7, the home screen 400 shows ten icons 405. The user can instruct the electronic apparatus 1 to execute the application corresponding to the icon 405 by performing a predetermined operation (e.g., a tap operation) on the icon 405. The controller 100 reads, from the storage 103, an application corresponding to the icon 405 on which the tap operation is performed and executes the application. That is to say, when the touch panel 130 detects the predetermined operation performed on the icon 405, the controller 100 reads, from the storage 103, the application corresponding to the icon 405 and executes the application. The user can thus select the icon 405 by operating the icon 405 and make the electronic apparatus 1 execute the application corresponding to the selected icon 405. For example, when the user performs the tap operation on the icon 405 corresponding to a browser, the electronic apparatus 1 executes the browser. When the user performs the tap operation on the icon 405 corresponding to a camera application, the electronic apparatus 1 executes the camera application.

<One Example of Fingerprint Authentication>

The controller 100 can perform a fingerprint authentication based on a fingerprint detection result in the fingerprint sensor 200. One example of the fingerprint authentication is described below.

In the fingerprint authentication, the controller 100 generates a fingerprint detected by the fingerprint sensor 200, that is to say, a fingerprint image indicating the detected fingerprint based on an output signal from the fingerprint sensor 200. Then, the controller 100 extracts a feature point indicating a feature of the detected fingerprint from the generated fingerprint image. Applied to the feature point are, for example, positions of an end point and a branch point of a ridge line (a convex portion) of the fingerprint and a thickness of the ridge line. Then, the controller 100 compares the extracted feature point and a reference feature point stored in the storage 103. The reference feature point is a feature point extracted from a fingerprint image showing a fingerprint of an authorized user (e.g., an owner of the electronic apparatus 1). The controller 100 determines that the fingerprint authentication has succeeded if the extracted feature point and the reference feature point are similar to each other as a result of comparison. The fingerprint authentication is one type of user authentication, and thus it can be said that the controller 100 determines that the user having the fingerprint detected by the fingerprint sensor 200 is the authorized user if the extracted feature point and the reference feature point are similar to each other. On the other hand, the controller 100 determines that the fingerprint authentication has failed if the extracted feature point and the reference feature point are not similar to each other. This means that the controller 100 determines that the user having the fingerprint detected by the fingerprint sensor 200 is an unauthorized user.

The normal mode includes a fingerprint registration mode for registering the fingerprint of the user in the electronic apparatus 1. The electronic apparatus 1 operates in the fingerprint registration mode when a predetermined operation is performed on the display surface 121 in the unlock mode. When the authorized user places his/her finger (particularly, a finger pad) on the display surface 121 in the fingerprint registration mode, the fingerprint sensor 200 detects the fingerprint of his/her finger. The controller 100 generates a fingerprint image indicating the fingerprint detected by the fingerprint sensor 200 based on an output signal from the fingerprint sensor 200. Then, the controller 100 extracts a feature point from the generated fingerprint image, and stores the extracted feature point in the storage 103 as the reference feature point. The reference feature point representing features of the fingerprint of the authorized user is thus stored in the storage 103. This means that the fingerprint of the authorized user is registered in the electronic apparatus 1.

In some cases, a plurality of reference feature points are stored in the storage 103. In this case, the controller 100 compares the extracted feature point with each of the plurality of reference feature points stored in the storage 103. The controller 100 determines that the fingerprint authentication has succeeded if the extracted feature point is similar to any of the plurality of reference feature points. On the other hand, the controller 100 determines that the fingerprint authentication has failed if the extracted feature point is similar to none of the plurality of reference feature points. The plurality of reference feature points stored in the storage 103 may include a plurality of feature points extracted from fingerprint images of fingerprints of a plurality of fingers of a single person, or include a plurality of feature points extracted from fingerprint images of fingerprints of fingers of a plurality of persons. In other words, the plurality of reference feature points stored in the storage 103 may include a plurality of feature points indicating the features of the fingerprints of the plurality of fingers of the single person, respectively, or include a plurality of feature points indicating the features of the fingerprints of the fingers of the plurality of persons.

<One Example of Setting of Unlock Mode by Operating Display Surface>

In the present example, when the operation mode is the sleep mode, the user can make the electronic apparatus 1 set the operation mode to the unlock mode by performing a predetermined operation on the display surface 121 with his/her finger. In the present example, when the operation mode is the lock mode, the user can make the electronic apparatus 1 set the operation mode to the unlock mode by performing a predetermined operation on the display surface 121 with his/her finger.

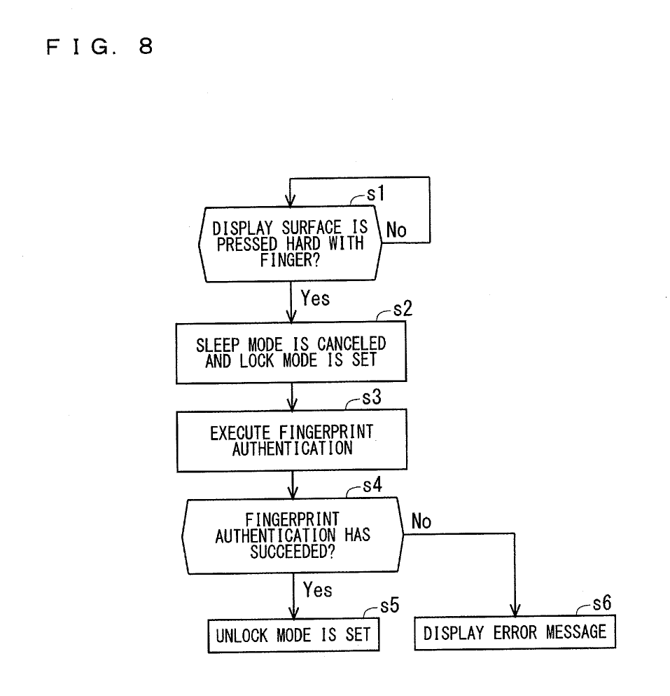

FIG. 8 is a flow chart showing one example of an operation of the electronic apparatus 1 operating in the sleep mode when the electronic apparatus 1 sets the operation mode to the unlock mode in accordance with the operation of the finger performed on the display surface 121. In the present example, in the sleep mode, the sensor 210 operates, however, the operation of the fingerprint sensor 200 is suspended. The fingerprint sensor 200 may operate in the sleep mode.

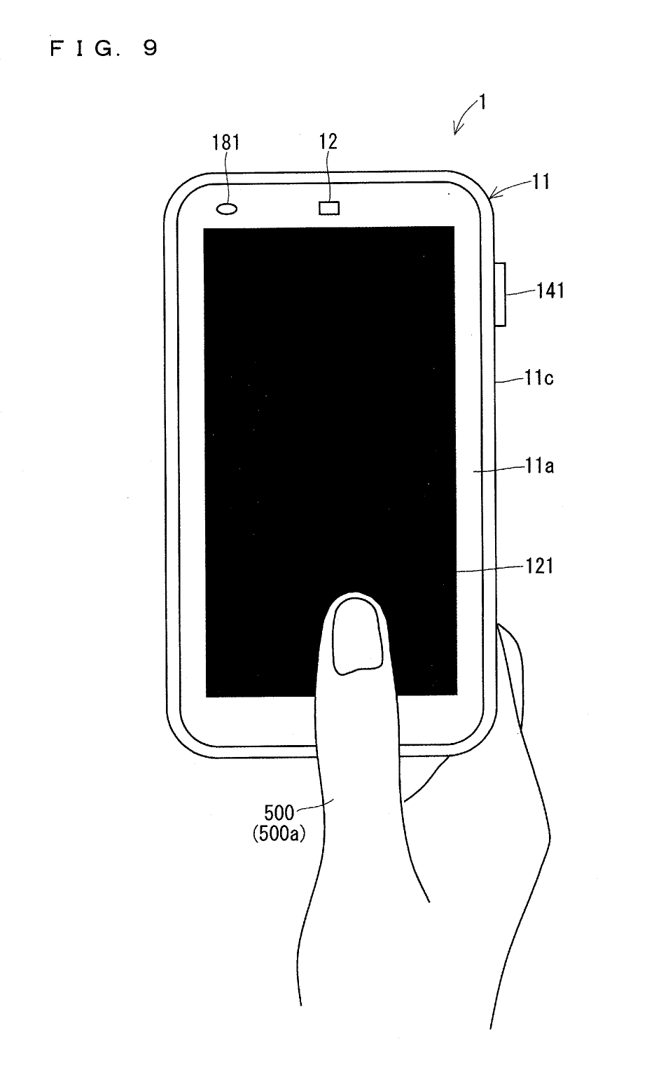

As shown in FIG. 8, in a case where the operation mode is the sleep mode, the controller 100 determines whether or not the display surface 121 is pressed hard with the finger in Step s1. FIG. 9 illustrates a drawing showing one example of the user pressing the display surface 121 hard with a finger 500 when the operation mode is the sleep mode. In the example in FIG. 9, the user presses the display surface 121 with a thumb 500a.

The controller 100 can determine whether or not the display surface 121 is pressed hard with the finger based on the detection result in the sensor 210. If a pressing force detected by the sensor 210 is larger than a first threshold value, the controller 100 determines that the display surface 121 is pressed hard with the finger. In the meanwhile, if the pressing force detected by the sensor 210 is equal to or smaller than the first threshold value, the controller 100 determines that the display surface 121 is not pressed hard with the finger. It is also applicable that the controller 100 determines that the display surface 121 is pressed hard with the finger if the pressing force detected by the sensor 210 is equal to or larger than the first threshold value, and determines that the display surface 121 is not pressed hard with the finger if the pressing force is smaller than the first threshold value.

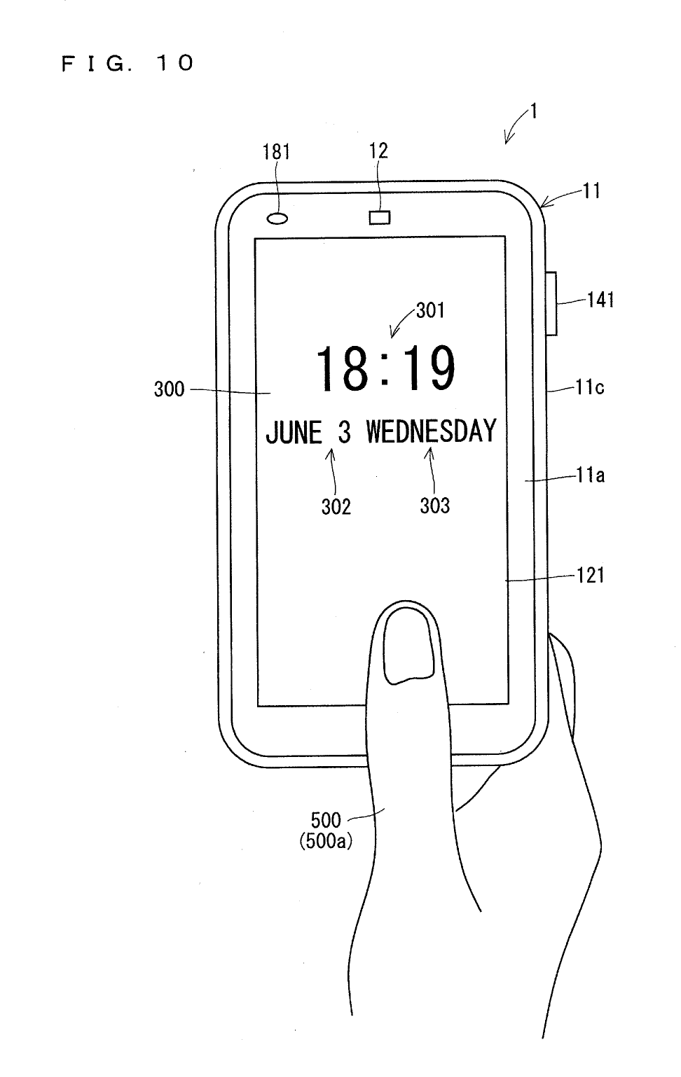

If it is determined that the display surface 121 is pressed hard with the finger in Step s1, the controller 100 cancels the sleep mode and sets the operation mode to the lock mode in Step s2. The lock screen 300 is thus displayed on the display surface 121 as shown in FIG. 10. The fingerprint sensor 200 operates in the lock mode. In the meanwhile, if it is determined that the display surface 121 is not pressed hard with the finger in Step s1, the controller 100 executes Step s1 again, and subsequently operates in the similar manner.

After Step s2, the controller 100 performs the fingerprint authentication based on the fingerprint detection result in the fingerprint sensor 200 as described above in Step s3. The fingerprint detection result used in the Step s3 is the fingerprint detection result which is obtained when it is determined that the display surface 121 is pressed hard with the finger in Step s1 and corresponding to the finger.

After Step s3, the controller 100 determines whether or not the fingerprint authentication has succeeded in Step s4. If it is determined that the fingerprint authentication has succeeded in Step s4, the controller 100 changes operation mode from the lock mode to the unlock mode in Step s5, and displays the home screen 400 on the display surface 121, for example (refer to FIG. 7).

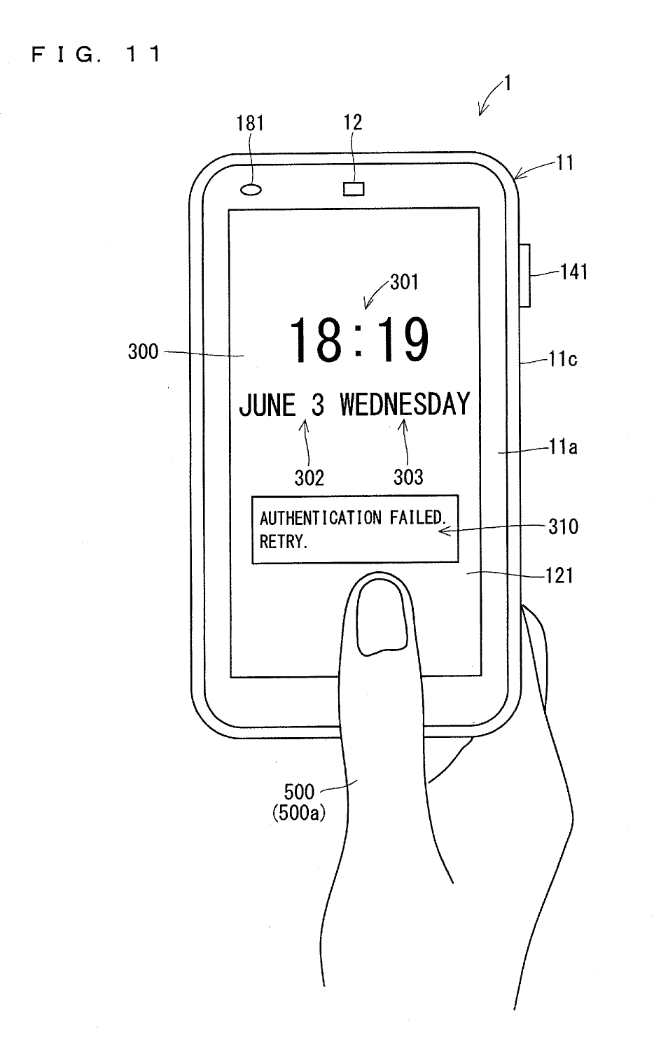

In the meanwhile, if it is determined that the fingerprint authentication has failed in Step s4, the controller 100 displays an error message on the display surface 121 in Step s6. FIG. 11 is a drawing showing one example of a display of an error message 310. The error message 310 is deemed to be information indicating that the fingerprint authentication has failed. As shown in FIG. 11, the error message 310 is displayed over the lock screen 300, for example. The error message 310 is not limited to the example in FIG. 11.

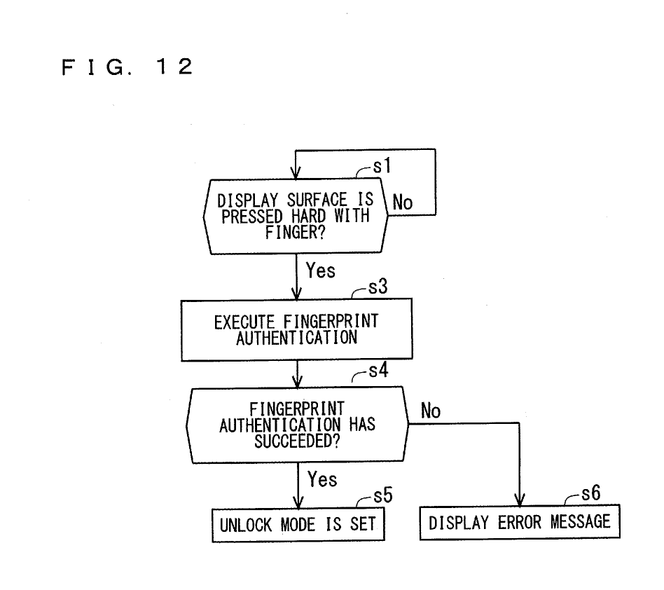

FIG. 12 is a flow chart showing one example of an operation of the electronic apparatus 1 operating in the lock mode when the electronic apparatus 1 sets the operation mode to the unlock mode in accordance with the operation of the finger performed on the display surface 121.

As shown in FIG. 12, in the case where the operation mode is the lock mode, the controller 100 executes Step s1 described above to determine whether or not the display surface 121 is pressed hard with the finger. If it is determined that the display surface 121 is pressed hard with the finger in Step s1, the controller 100 executes Step s3 described above to perform the fingerprint authentication. In the meanwhile, if it is determined that the display surface 121 is not pressed hard with the finger in Step s1, the controller 100 executes Step s1 again, and subsequently operates in the similar manner.

After Step s3, the controller 100 executes Steps s4 to s6 in the similar manner. If the display surface 121 is touched with the finger again after Step s6, Step s1 is executed, and the controller 100 subsequently operates in the similar manner. The controller 100 can specify that the display surface 121 is touched with the finger again based on the output signal from the touch panel 130, for example. In the example in FIG. 8 described above, if the display surface 121 is touched with the finger again after Step s6, Step s1 is executed, and the controller 100 subsequently operates in the similar manner.

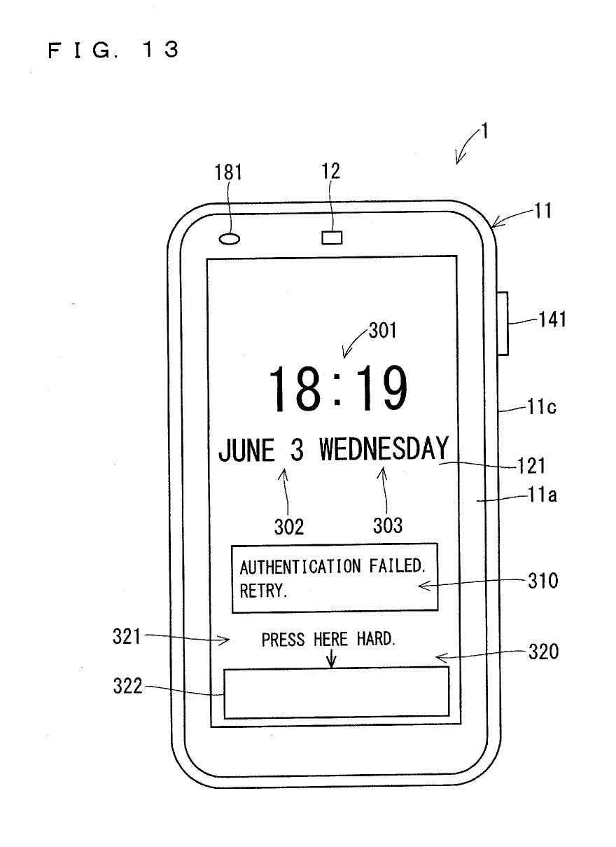

As can be understood from the above description, in the state where the operation mode is the sleep mode or the lock mode, if the authorized user presses the detection region 201 being set in the display surface 121 with the finger hard, the fingerprint authentication succeeds and the operation mode is set to the unlock mode in the electronic apparatus 1. In the meanwhile, if the unauthorized user presses the detection region 201 being set in the display surface 121 with the finger hard, the fingerprint authentication fails and the operation mode is not set to the unlock mode in the electronic apparatus 1. If a region other than the detection region 201 in the display surface 121 is pressed with the finger hard, the fingerprint sensor 200 cannot detect the fingerprint, thus the fingerprint authentication in Step s3 fails. Accordingly, if the region other than the detection region 201 in the display surface 121 is pressed with the finger hard, the operation mode is not set to the unlock mode in the electronic apparatus 1 regardless of whether or not the user who has pressed the display surface 121 is the authorized user. If the fingerprint authentication in Step s3 has failed by reason that the region other than the detection region 201 has been pressed with the finger hard, that is to say, if the fingerprint authentication has failed by reason that the fingerprint sensor 200 has not detected the fingerprint, the controller 100 may display notification information 320 for notifying the user of the position of the detection region 201 on the display surface 121 in Step s6. FIG. 13 is a drawing showing a display example of the notification information 320. In the example in FIG. 13, the detection region 201 is set on the lower end portion of the display surface 121 as shown in FIG. 5 described above. In the example in FIG. 13, the notification information 320 includes a graphic 322 indicating a position of the detection region 201 and instruction information 321 instructing the user to press the region indicated by the graphic 322 with the finger hard. The instruction information 321 includes a character string and an arrow. A display example of the notification information 320 is not limited to the example in FIG. 13.

In Step s5, the screen which has been displayed on the display surface 121 immediately before the operation mode is set to the sleep mode may be displayed on the display surface 121. In such a case, if the screen of the browser being executed has been displayed on the display surface 121 immediately before the operation mode is set to the sleep mode, the screen of the browser is displayed in Step s5.

In the example in FIG. 8 described above, Step s2 is executed when the display surface 121 is pressed with the finger hard, however, Step s2 may be executed when the display surface 121 is touched with the finger regardless of the pressing force exerted by the finger on the display surface 121. In such a case, the controller 100 activates the touch panel 130 in the sleep mode, for example. The controller 100 determines whether or not the display surface 121 is touched with the finger based on the output signal from the touch panel 130 in Step s1. If it is determined that the display surface 121 is touched with the finger, the controller 100 executes Step s2. In the similar manner, in the example in FIG. 12, Step s3 may be executed when the display surface 121 is touched with the finger regardless of the pressing force exerted by the finger on the display surface 121. The controller 100 may activate the fingerprint sensor 200 in the sleep mode to determine whether or not the display surface 121 is touched with the finger based on the output signal from the fingerprint sensor 200.

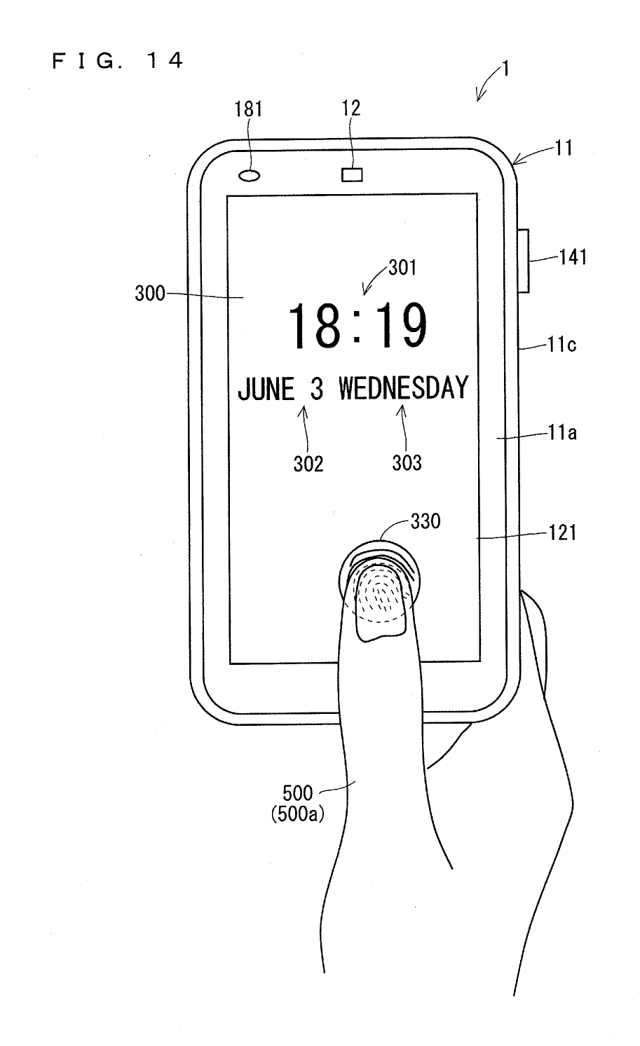

In the examples in FIGS. 8 and 12, if the lock screen 300 is displayed, the controller 100 may display a display object 330 in a position touched with the finger in the display surface 121. In the flow chart in FIG. 8, the controller 100 may display the display object 330 in the position touched with the finger in the display surface 121 after the execution of Step s2 and before the execution of Step s5, for example. In the flow chart in FIG. 8, the controller 100 may display the display object 330 in the position touched with the finger in the display surface 121 after the execution of Step s2 and before the execution of Step s6, for example. In the flow chart in FIG. 12, the controller 100 may display the display object 330 in the position touched with the finger in the display surface 121 after the execution of Step s1 and before the execution of Step s5, for example. In the flow chart in FIG. 12, the controller 100 may display the display object 330 in the position touched with the finger in the display surface 121 after the execution of Step s1 and before the execution of Step s6, for example. FIG. 14 is a drawing showing a display example of the display object 330. As shown in FIG. 14, the display object 330 is displayed in such a manner that part of the display object 330 is not covered with the finger 500 pressing the display surface 121 hard. In the example in FIG. 14, the display object 330 forms a graphic expressing a fingerprint of a finger of a person. A shape of the display object 330, for example, is not limited to the example in FIG. 13.

Since the display object 330 is displayed in the position touched with the finger in the display surface 121, the user can easily recognize that the operation performed by himself/herself on the display surface 121 is received by the electronic apparatus 1. Thus, the convenience of the electronic apparatus 1 is improved. Since the display object 330 indicates the fingerprint of the finger of the person, the user can easily recognize that the electronic apparatus 1 performs the fingerprint authentication. Thus, the convenience of the electronic apparatus 1 is improved.

<One Example of Operation of Electronic Apparatus when Display Object is Operated>

In the state where the operation mode is the unlock mode, the controller 100 can perform a processing lock setting on a specific display object displayed on the display surface 121. The processing lock setting is a setting of performing the fingerprint authentication if the specific display object is touched with the finger, and performing processing relating to the specific display object (referred to as “the related processing” in some cases hereinafter) if the fingerprint authentication succeeds and not performing the processing if the fingerprint authentication fails. The display object on which the processing lock setting can be performed includes the icon 405 and a photographed image. The photographed image is an image taken with a camera. The display object on which the processing lock setting can be performed is simply referred to as “the specific display object” in some cases hereinafter. The display object on which the processing lock setting is performed is simply referred to as “the lock display object” in some cases.

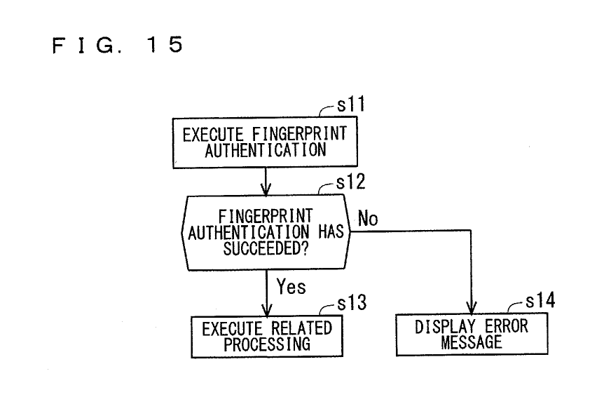

FIG. 15 is a drawing showing one example of the operation of the electronic apparatus 1 when a predetermined operation is performed on the lock display object with the finger. If the predetermined operation is performed on the lock display object with the finger, the controller 100 performs the fingerprint authentication based on the fingerprint detection result corresponding to the finger in the fingerprint sensor 200 in Step s11. Next, in Step s12, the controller 100 determines whether or not the fingerprint authentication in Step s11 has succeeded. If it is determined that the fingerprint authentication has succeeded in Step s12, the controller 100 executes the related processing relating to the lock display object on which the predetermined operation has been performed with the finger in Step s13. In the meanwhile, if it is determined that the fingerprint authentication has failed in Step s12, the controller 100 does not execute the related processing but displays an error message on the display surface 121 in Step s14. It is not necessary to execute Step s14. A series of operations shown in FIG. 15 is described in further detail with a specific example of the lock display object hereinafter.

<Operation Example when Icon on which Processing Lock Setting is Performed is Operated>

In the state where the processing lock setting is not performed on the icon 405 displayed on the display surface 121, if the tap operation is performed on the icon 405 with the finger, the controller 100 reads, from the storage 103, the application corresponding to the icon 405 and executes the application as described above.

In the meanwhile, if the tap operation is performed on the icon 405 on which the processing lock setting is performed with the finger, the controller 100 performs the fingerprint authentication based on the fingerprint detection result in the fingerprint sensor 200 (Step s11). If the icon 405 on which the processing lock setting is performed is touched with the finger in the tap operation performed with the finger on the icon 405, the controller 100 starts the fingerprint authentication. If the fingerprint authentication succeeds (YES in Step s12), the controller 100 reads, from the storage 103, the application corresponding to the icon 405 on which the tap operation has been performed and executes the application (Step s13). In the meanwhile, if the fingerprint authentication fails (NO in Step s12), the controller 100 does not execute the application corresponding to the icon 405 on which the tap operation has been performed but displays the error message on the display surface 121 (Step s14).

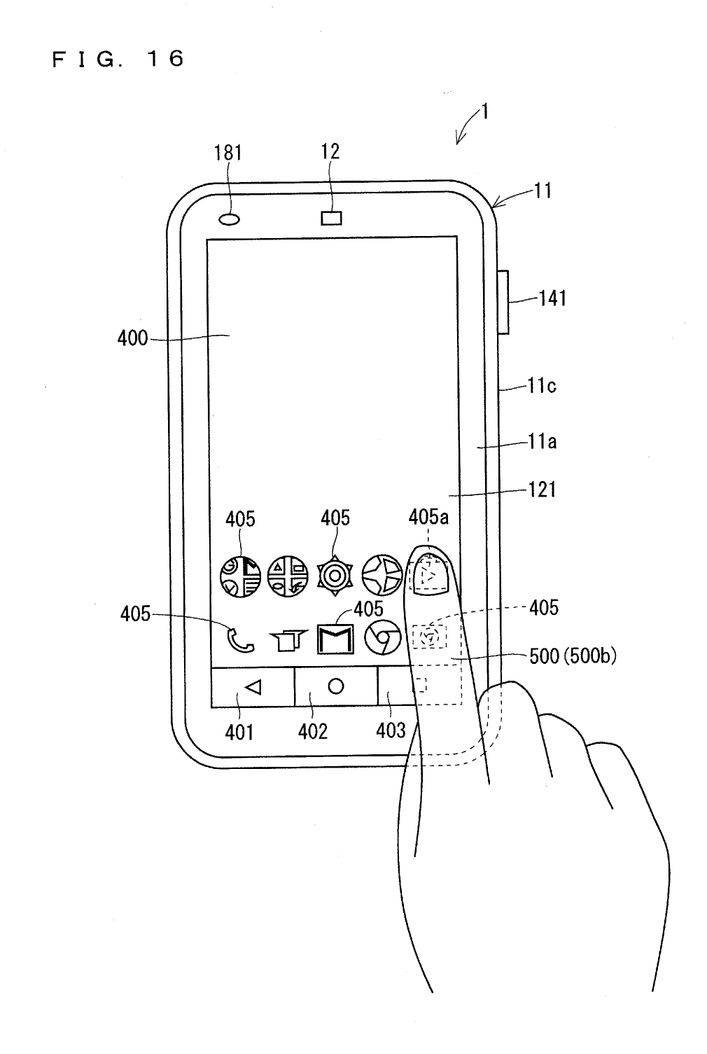

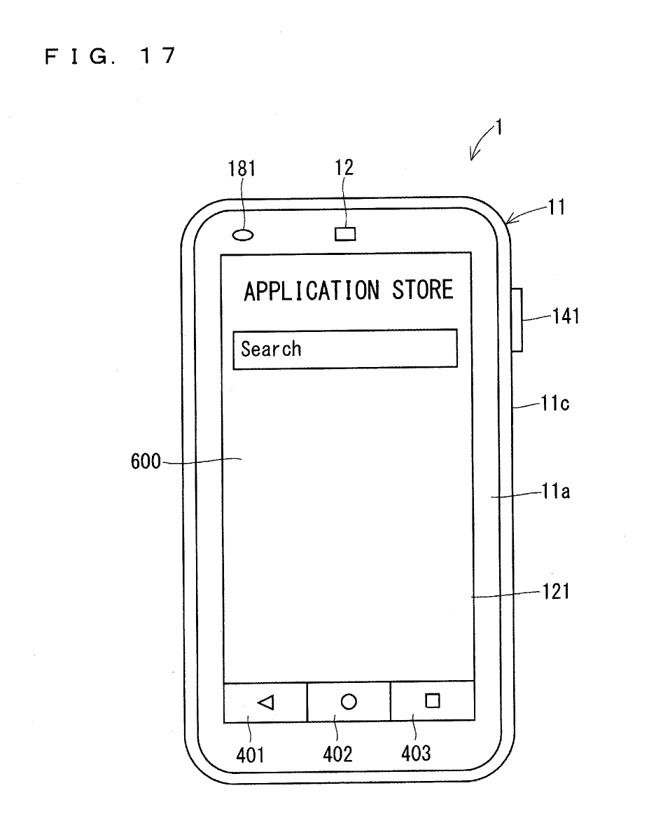

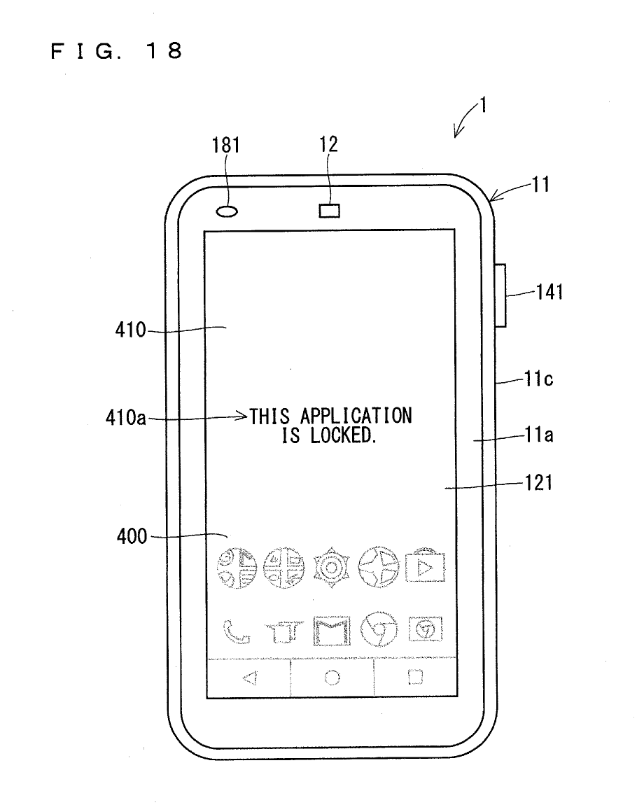

Considered, for example, is a case where the processing lock setting is performed on an icon 405a corresponding to an application for displaying a website via which the electronic apparatus 1 downloads applications (referred to as “the store application” hereinafter). In this case, if the user touches the icon 405a with the finger 500 as shown in FIG. 16 in performing the tap operation on the icon 405 with the finger 500, the controller 100 performs the fingerprint authentication based on the fingerprint detection result in the fingerprint sensor 200. FIG. 16 shows a state where the icon 405a is operated by an index finger 500b. If the tap operation is performed on the icon 405a with the finger 500 and the fingerprint authentication succeeds, the controller 100 executes the store application corresponding to the icon 405a. The display surface 121 thereby displays a predetermined webpage 600 of the website via which the electronic apparatus 1 downloads the applications as shown in FIG. 17. In the meanwhile, if the tap operation is performed on the icon 405a with the finger 500 and the fingerprint authentication fails, the controller 100 does not execute the store application. Then, as shown in FIG. 18, the controller 100 displays a notification screen 410 including an error message 410a on the display surface 121, for example. At this time, a semi-transparent notification screen 410 may be displayed over the home screen 400 as shown in FIG. 18. The error message 410a is deemed to be information indicating that the processing lock setting is performed on the icon 405a. The error message 410a is also deemed to be information indicating that the fingerprint authentication has failed. The display of the notification screen 410 may be cleared after an elapse of a certain period of time, or may be cleared in accordance with the operation performed by the user on the display surface 121. The notification screen 410 may be a non-transparent screen. The notification screen 410 needs not be displayed.

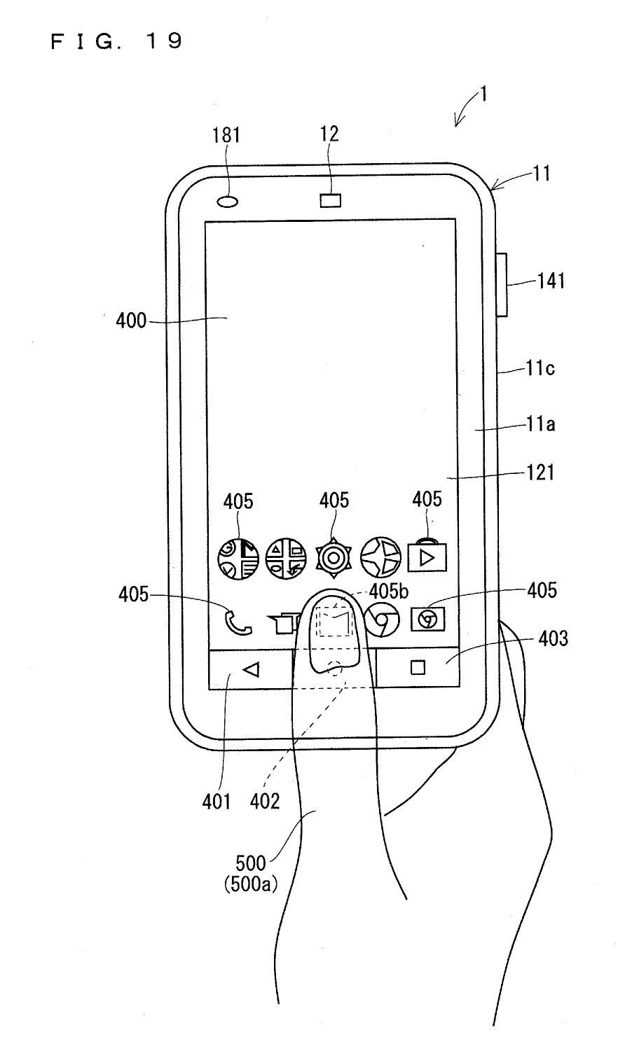

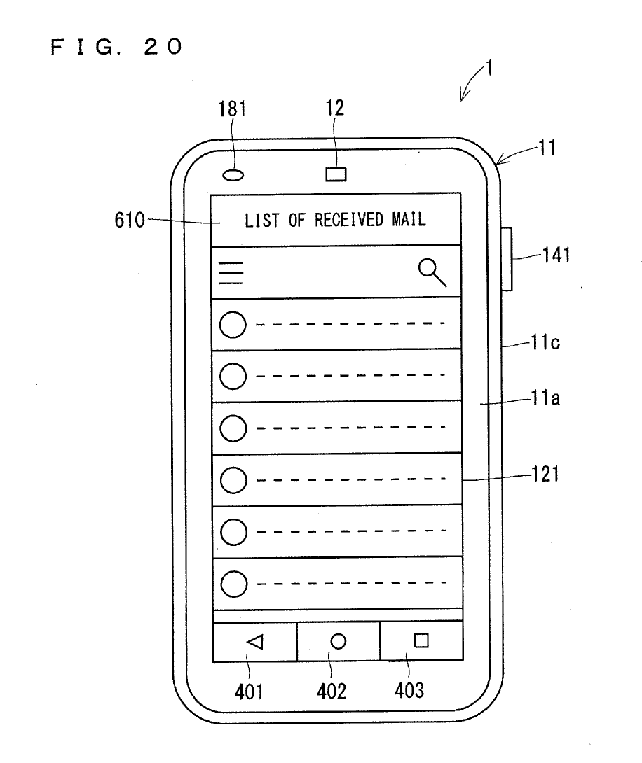

Considered, for example, is a case where the processing lock setting is performed on an icon 405b corresponding to a mail application. In this case, if the user touches the icon 405b with the finger 500 as shown in FIG. 19 in performing the tap operation on the icon 405b with the finger 500, the controller 100 performs the fingerprint authentication based on the fingerprint detection result in the fingerprint sensor 200. If the tap operation is performed on the icon 405b with the finger 500 and the fingerprint authentication succeeds, the controller 100 executes the mail application corresponding to the icon 405b. A received mail screen 610 indicating a list of received mails is thereby displayed on the display surface 121 as shown in FIG. 20, for example. In the meanwhile, if the fingerprint authentication fails, the controller 100 does not execute the mail application even in the case where the tap operation is performed on the icon 405b with the finger 500. Then, as shown in FIG. 18 described above, the controller 100 displays the notification screen 410 including the error message 410a on the display surface 121, for example.

As described above, in the case where the processing lock setting is performed on the icon 405, the controller 100 executes the application corresponding to the icon 405 when the fingerprint authentication succeeds, and does not execute the application corresponding to the icon 405 when the fingerprint authentication fails. Accordingly, the controller 100 executes the application corresponding to the icon 405 if the authorized user operates the icon 405, and does not execute the application corresponding to the icon 405 if the unauthorized user operates the icon 405. Thus, the unauthorized user has difficulty making the electronic apparatus 1 execute the application corresponding to the icon 405 on which the processing lock setting is set. As a result, the convenience of the electronic apparatus 1 is improved.

If the authorized user touches the icon 405 with his/her finger, the authorized user can make the electronic apparatus 1 execute the fingerprint authentication and the application corresponding to the icon 405. Thus, operability of the electronic apparatus 1 is improved.

The operation performed on the icon 405 is not limited to the tap operation. For example, if a long tap operation is performed on the icon 405, the controller 100 may delete the application corresponding to the icon 405 from the storage 103 and clear the display of the icon 405. In this case, in the state where the processing lock setting is performed on the icon 405, the controller 100 executes the fingerprint authentication if the long tap operation is performed on the icon 405. If the fingerprint authentication succeeds, the controller 100 deletes, from the storage 103, the application corresponding to the icon 405 on which the long tap operation has been performed, and clears the display of the icon 405. In the meanwhile, if the fingerprint authentication fails, the controller 100 does not delete, from the storage 103, the application corresponding to the icon 405 on which the long tap operation has been performed. At this time, the controller 100 may display the error message on the display surface 121.

<Operation Example when Photographed Image on which Processing Lock Setting is Performed is Operated>

In the state where the processing lock setting is not performed on the photographed image displayed on the display surface 121 during the execution of a recorded image display application, if an operation of transmitting an instruction to execute the related processing relating to the photographed image (also referred to as “the execution instruction operation” in some cases hereinafter) is performed on the photographed image with the finger, the controller 100 executes the related processing. The related processing includes, for example, a deletion of the photographed image, a display of an edit screen of the photographed image, an upload of the photographed image to a web server such as social networking service (SNS), and the like.

In the meanwhile, if the execution instruction operation is performed on the photographed image on which the processing lock setting is performed with the finger, the controller 100 performs the fingerprint authentication based on the fingerprint detection result corresponding to the finger in the fingerprint sensor 200 (Step s11). If the photographed image on which the processing lock setting is performed is touched with the finger in the execution instruction operation performed with the finger on the photographed image, the controller 100 starts the fingerprint authentication. If the fingerprint authentication succeeds (YES in Step s12), the controller 100 executes the related processing relating to the photographed image on which the execution instruction operation has been performed (Step s13). In the meanwhile, if the fingerprint authentication fails (NO in Step s12), the controller 100 does not execute the related processing relating to the photographed image on which the execution instruction operation has been operated but displays the error message on the display surface 121 (Step s14).

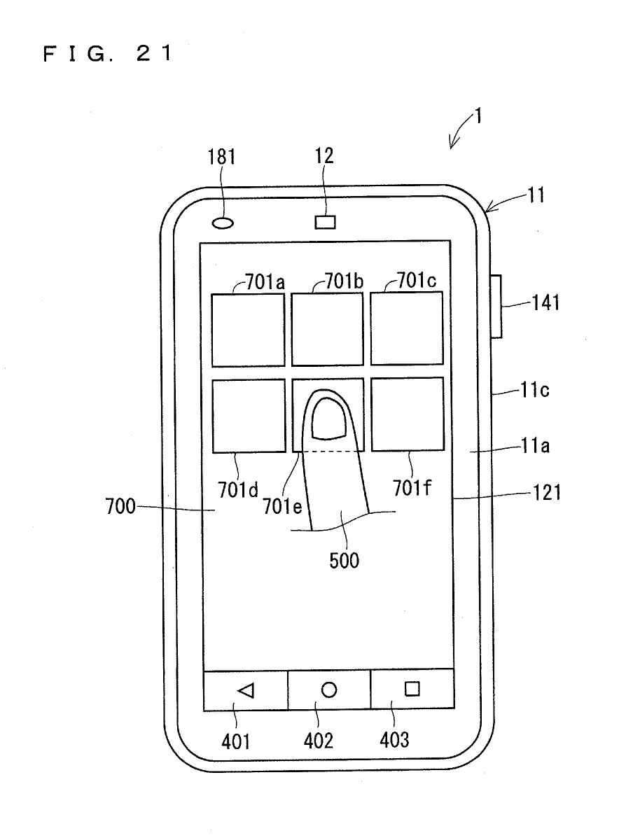

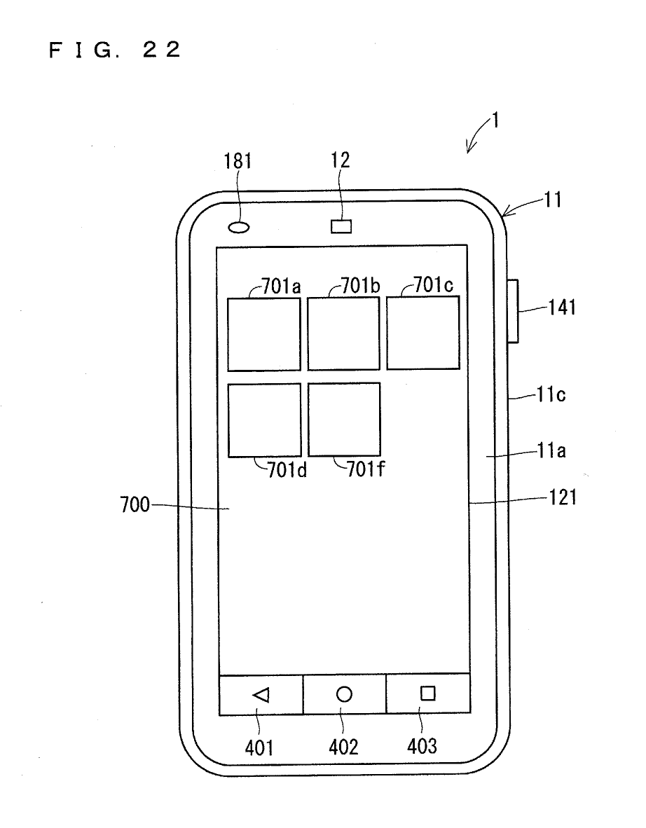

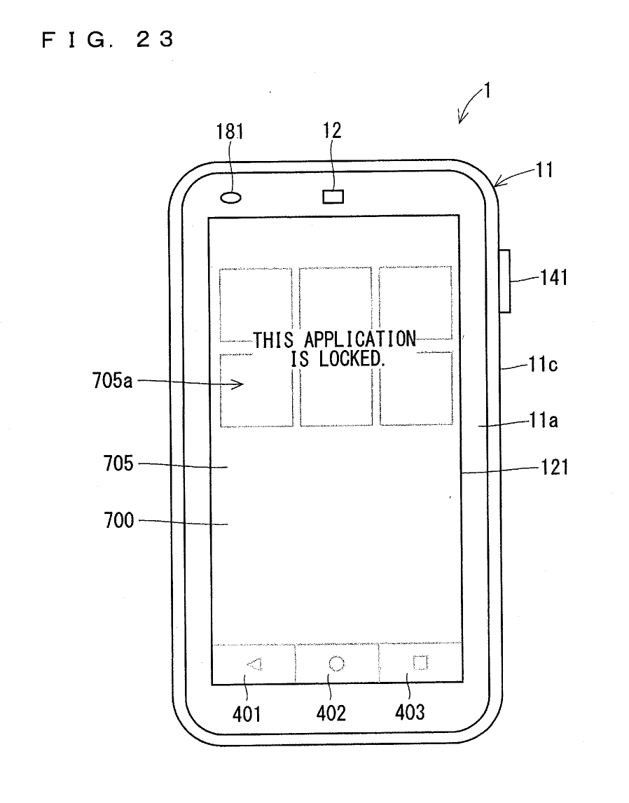

Considered, for example, is a case where a screen 700 including a plurality of photographed images 701a to 701f and the operation buttons 401 to 403 is displayed on the display surface 121 as shown in FIG. 21. It is assumed that the long tap operation performed on the photographed image is the execution instruction operation of transmitting the instruction to delete the photographed image, for example. In such a case, if the user touches the photographed image 701e with the finger 500 as shown in FIG. 21 in performing the long tap operation on the photographed image 701e on which the processing lock setting is performed with the finger 500, the controller 100 performs the fingerprint authentication based on the fingerprint detection result in the fingerprint sensor 200. If the long tap operation is performed on the photographed image 701e with the finger 500 and the fingerprint authentication succeeds, the controller 100 deletes the photographed image 701e from the storage 103. The display of the photographed image 701e is thereby deleted as shown in FIG. 22. In the meanwhile, if the fingerprint authentication fails, the controller 100 does not delete the photographed image 701e from the storage 103 even in the case where the long tap operation is performed on the photographed image 701e with the finger 500. Then, as shown in FIG. 23, the controller 100 displays a notification screen 705 including an error message 705a on the display surface 121, for example. At this time, a semi-transparent notification screen 705 may be displayed over the screen 700 including the plurality of photographed images 701a to 701f as shown in FIG. 23. The error message 705a is deemed to be information indicating that the processing lock setting is performed on the photographed image 701e. The error message 705a is also deemed to be information indicating that the fingerprint authentication has failed. The display of the notification screen 705 may be cleared after an elapse of a certain period of time, or may be cleared in accordance with the operation performed by the user on the display surface 121. The notification screen 705 may be a non-transparent screen. The notification screen 705 needs not be displayed.

As described above, in the present example, if the authorized user touches the lock display object with his/her finger, the authorized user can make the electronic apparatus 1 execute the fingerprint authentication and the processing relating to the lock display object, thus, the operability of the electronic apparatus 1 is improved.

<One Example of Method of Performing Processing Lock Setting on Display Object>

In the present example, the controller 100 can separately perform the processing lock setting on each specific display object displayed on the display surface 121. In the present example, a normal mode includes a setting mode to perform the processing lock setting on the specific display object. The electronic apparatus 1 operates in the setting mode when a predetermined operation is performed on the display surface 121 in the unlock mode. In the setting mode, the user can perform the processing lock setting on the specific display object by performing the predetermined operation on the display surface 121. For example, in the state where the operation mode is the setting mode, if the long tap operation is performed on the icon 405 displayed on the display surface 121, the processing lock setting is performed on the icon 405. In the state where the operation mode is the setting mode, if the long tap operation is performed on the photographed image displayed on the display surface 121, the processing lock setting is performed on the photographed image. A method of performing the processing lock setting on the specific display object is not limited thereto.

As described above, in the present example, if the display surface 121, which is in the non-display state, is touched with the finger, the controller 100 changes the state of the display surface 121 to the display state, and performs the fingerprint authentication based on the fingerprint detection result corresponding to the finger. Thus, the authorized user can make the electronic apparatus 1 execute the fingerprint authentication while making the display surface 121 be in the display state by touching the display surface 121 with his/her finger. Thus, the operability of the electronic apparatus 1 is improved.

The fingerprint sensor 200 can detect the fingerprint of the finger touching the display surface 121, that is to say, the fingerprint detection region 201 is set in the display surface 121, thus the surface of the electronic apparatus 1 can be effectively used compared with a case where the fingerprint detection region 201 is set in a region different from a region where the display surface 121 is included.

The fingerprint detection region 201 is set in the display surface 121, thus the user can easily touch the display surface 121 with his/her finger for other purposes after touching the display surface 121 with his/her finger for the fingerprint authentication. Thus, the operability of the electronic apparatus 1 is improved.

If the lock display object displayed on the display surface 121 is touched with the finger, the controller 100 performs the fingerprint authentication based on the fingerprint detection result corresponding to the finger in the fingerprint sensor 200. The controller 100 executes the processing relating to the lock display object touched with the finger if the fingerprint authentication succeeds, and does not execute the processing if the fingerprint authentication fails. Thus, the unauthorized user has difficulty making the electronic apparatus 1 execute the processing. As a result, the convenience of the electronic apparatus 1 is improved. If the authorized user touches the lock display object with his/her finger, the authorized user can make the electronic apparatus 1 execute the fingerprint authentication and the processing relating to the lock display object, thus, the operability of the electronic apparatus 1 is improved.

The controller 100 may change the processing in accordance with the finger touching the lock display object. Considered, for example, is a case where fingerprints of fingers of a plurality of persons are registered in the electronic apparatus 1 if the electronic apparatus 1 is shared by the plurality of persons. In this case, the controller 100 may change the processing in accordance with the user having the fingerprint, detected in the fingerprint sensor 200, of the finger touching the lock display object. The operation of the electronic apparatus 1 in this case is described in detail hereinafter. The operation of the electronic apparatus 1 is described with an example of sharing the electronic apparatus 1 by users A and B.

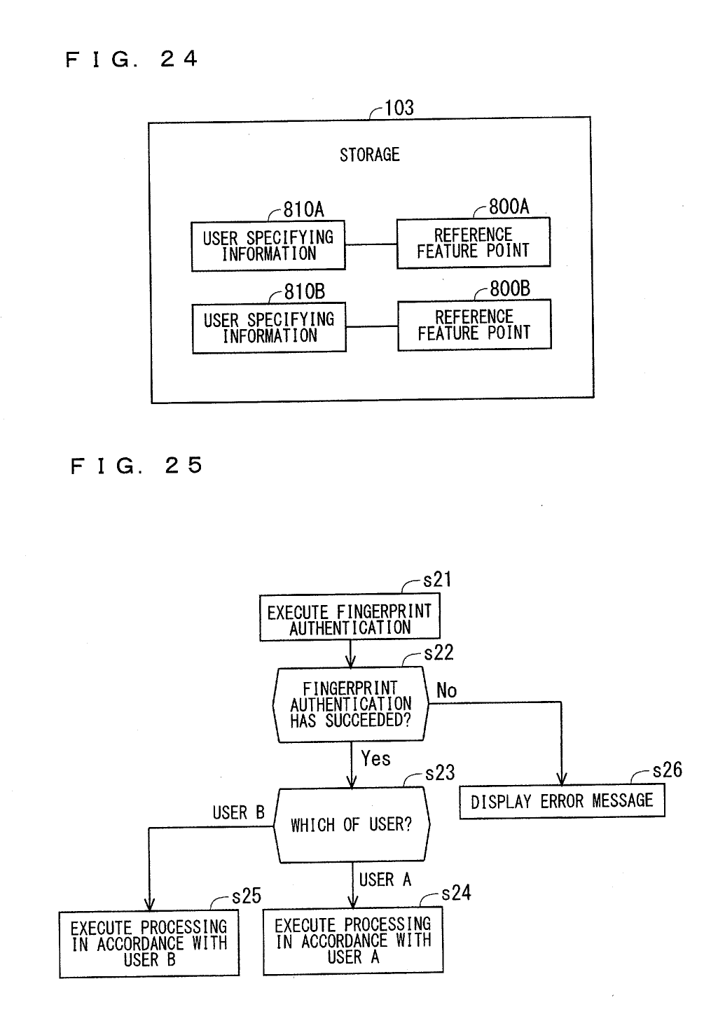

As shown in FIG. 24, the storage 103 registers a reference feature point 800A extracted from a fingerprint image showing a fingerprint of a finger of a user A and a reference feature point 800B extracted from a fingerprint image showing a fingerprint of a finger of a user B. In the storage 103, user specifying information 810A for specifying the user A and the reference feature point 800A are associated with each other, and user specifying information 810B for specifying the user B and the reference feature point 800B are associated with each other. If the operation mode is the fingerprint registration mode, the user can input the user specifying information for specifying the user to the electronic apparatus 1 by performing a predetermined operation on the display surface 121. The controller 100 associates the user specifying information which has been input with the extracted reference feature point, and stores them in the storage 103. The user specifying information includes a name of the user, for example.

FIG. 25 is a flow chart showing one example of an operation of the electronic apparatus 1. If the predetermined operation is performed on the lock display object, the controller 100 performs the fingerprint authentication based on the fingerprint detection result corresponding to the finger in the fingerprint sensor 200 in Step s21. Next, in Step s22, the controller 100 determines whether or not the fingerprint authentication in Step s21 has succeeded. If it is determined that the fingerprint authentication has failed in Step s22, the controller 100 displays the error message on the display surface 121 in Step s26. It is not necessary to execute Step s26.

In the meanwhile, if it is determined that the fingerprint authentication has succeeded in Step s22, the controller 100 specifies the user having the fingerprint detected by the fingerprint sensor 200 in Step s23. If the user having the fingerprint detected by the fingerprint sensor 200 is the user A, the controller 100 executes the processing in accordance with the user A in Step s24. If the user having the fingerprint detected by the fingerprint sensor 200 is the user B, the controller 100 executes the processing in accordance with the user B in Step s25. The controller 100 can specify the user specifying information associated with the reference feature point similar to the feature point extracted from the fingerprint image indicating the fingerprint detected by the fingerprint sensor 200, and specify the user having the fingerprint detected by the fingerprint sensor 200 from the specified user specifying information. The operation of one example shown in FIG. 25 is described in further detail with a specific example of the lock display object hereinafter.

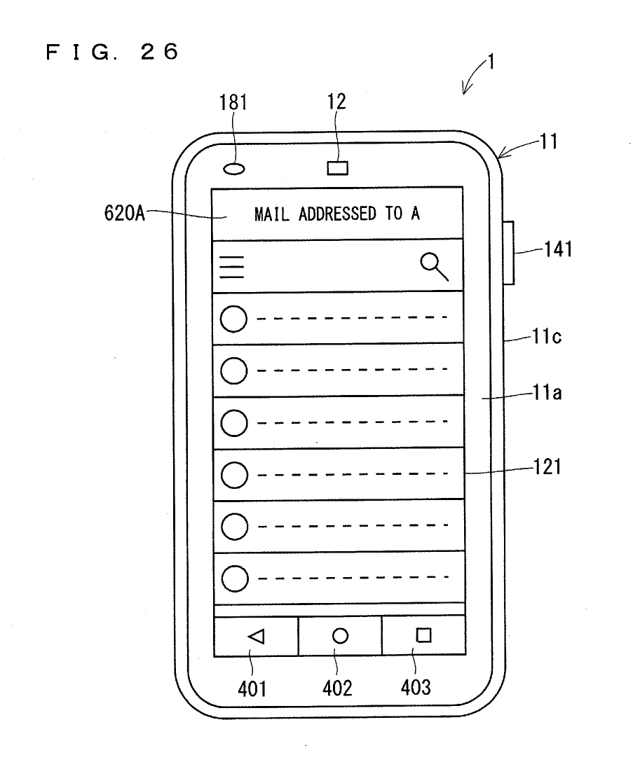

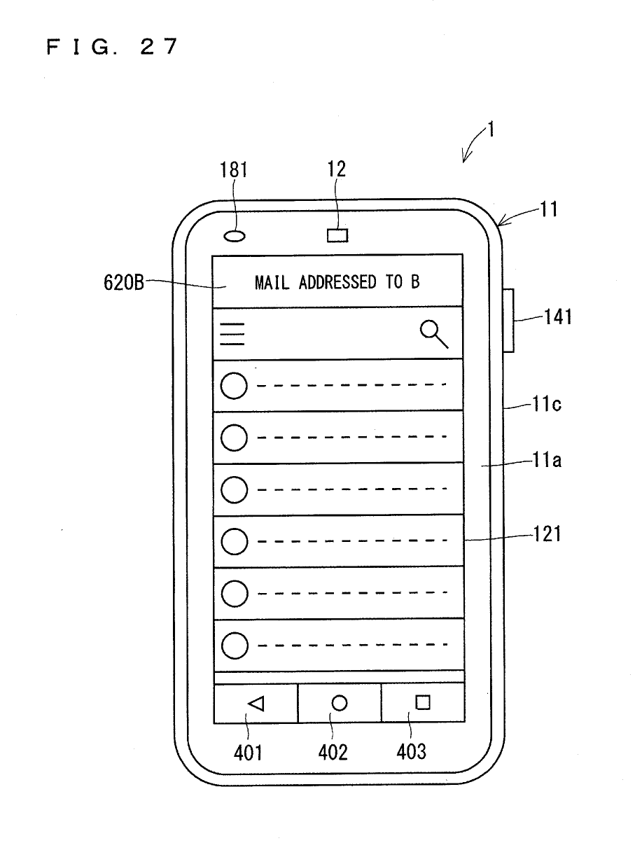

For example, as shown in FIG. 19 described above, if the tap operation is performed on the icon 405b, corresponding to the mail application, on which the processing lock setting is performed, the controller 100 performs the fingerprint authentication (Step s21). If the fingerprint authentication succeeds (YES in Step s22) and the user having the fingerprint detected by the fingerprint sensor 200 is the user A (the user A is specified in Step s23), the controller 100 executes the mail application, and displays a received mail screen 620A indicating a list of received mails addressed to the user A on the display surface 121, for example (Step s24). FIG. 26 is a drawing showing one example of the received mail screen 620A. If the fingerprint authentication succeeds (YES in Step s22) and the user having the fingerprint detected by the fingerprint sensor 200 is the user B (the user B is specified in Step s23), the controller 100 executes the mail application, and displays a received mail screen 620B indicating a list of received mails addressed to the user B on the display surface 121, for example (Step s25). FIG. 27 is a drawing showing one example of the received mail screen 620B. If the fingerprint authentication fails (NO in Step s22), the controller 100 displays the notification screen 410 including the error message 410a on the display surface 121 as shown in the example in FIG. 18 described above (Step s26). In this example, a mail address used by the user A and a mail address used by the user B are allocated to the electronic apparatus 1. The controller 100 extracts, from the storage 103, a received mail addressed to the mail address used by the user A as the received mail addressed to the user A, and displays the received mail screen 620A indicating the list of the extracted received mail on the display surface 121. In the similar manner, the controller 100 extracts, from the storage 103, a received mail addressed to the mail address used by the user B as the received mail addressed to the user B, and displays the received mail screen 620B indicating the list of the extracted received mail on the display surface 121.

If the tap operation is performed on the icon 405, corresponding to the application other than the mail application, on which the processing lock setting is performed, the controller 100 may change the processing in accordance with the user having the fingerprint detected by the fingerprint sensor 200. For example, if the tap operation is performed on the icon 405, corresponding to the call application, on which the processing lock setting is performed, the controller 100 may change the processing in accordance with the user having the fingerprint detected by the fingerprint sensor 200. In this case, if the tap operation is performed on the icon 405, corresponding to the call application, on which the processing lock setting is performed, the controller 100 performs the fingerprint authentication in the similar manner. If the fingerprint authentication succeeds and the user having the fingerprint detected by the fingerprint sensor 200 is the user A, the controller 100 executes the call application, and displays a history of received calls to the user A on the display surface 121, for example. If the fingerprint authentication succeeds and the user having the fingerprint detected by the fingerprint sensor 200 is the user B, the controller 100 executes the call application, and displays a history of received calls to the user B on the display surface 121, for example. If the fingerprint authentication fails, the controller 100 displays the notification screen 410 including the error message 410a on the display surface 121. In this example, a phone number used by the user A and a phone number used by the user B are allocated to the electronic apparatus 1. The controller 100 displays a history of a received call to the phone number used by the user A on the display surface 121 as the history of the received call to the user A. In the similar manner, the controller 100 displays a history of a received call to the phone number used by the user B on the display surface 121 as the history of the received call to the user B.

If the tap operation is performed on the icon 405, corresponding to the recorded image display application, on which the processing lock setting is performed, the controller 100 may change the processing in accordance with the user having the fingerprint detected by the fingerprint sensor 200. For example, if the tap operation is performed on the icon 405, corresponding to the recorded image display application, on which the processing lock setting is performed, the controller 100 performs the fingerprint authentication in the similar manner. If the fingerprint authentication succeeds and the user having the fingerprint detected by the fingerprint sensor 200 is the user A, the controller 100 executes the recorded image display application, and displays a photographed image relating to the user A on an upper side of the display surface 121 in priority to a photographed image relating to the user B, for example. If the fingerprint authentication succeeds and the user having the fingerprint detected by the fingerprint sensor 200 is the user B, the controller 100 executes the recorded image display application, and displays the photographed image relating to the user B on the upper side of the display surface 121 in priority to the photographed image relating to the user A, for example. If the fingerprint authentication fails, the controller 100 displays the notification screen 410 including the error message 410a on the display surface 121.

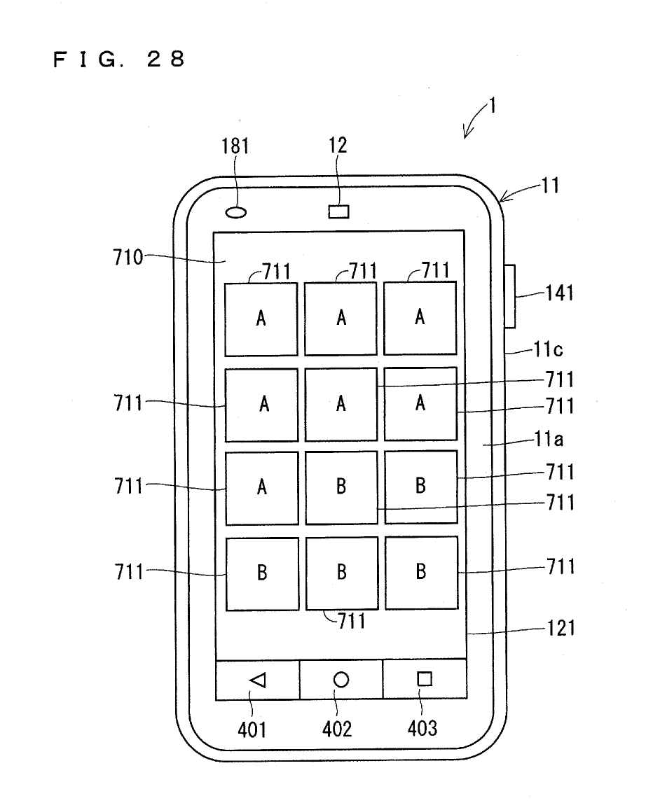

FIG. 28 is a drawing showing one example of photographed images 711 relating to the user A displayed on the upper side of the display surface 121 in priority to photographed images 711 relating to the user B. In the example in FIG. 28, a screen 710 including the plurality of photographed images 711 relating to the user A, the plurality of photographed images 711 relating the user B, and the operation buttons 401 to 403 is displayed on the display surface 121. In FIG. 28, “A” is shown in the photographed image 711 relating to the user A, and “B” is shown in the photographed image 711 relating to the user B for convenience.

The photographed image relating to the user A includes the photographed image 711 associated with the user specifying information 810A in the storage 103, for example. In the similar manner, the photographed image relating to the user B includes the photographed image 711 associated with the user specifying information 810B in the storage 103, for example. The user can make the electronic apparatus 1 associate the user specifying information for specifying the user with each photographed image in the storage 103 by operating the display surface 121.

A photographed image including an image of the user A may be adopted as the photographed image relating to the user A, and an image including an image of the user B may be adopted as the photographed image relating to the user B. In this case, for example, the user specifying information 810A includes a face image of a face of the user A, and the user specifying information 810B includes a face image of a face of the user B. The controller 100 specifies, from the plurality of photographed images 711 in the storage 103, the photographed image 711 including the face image included in the user specifying information 810A, and displays the specified photographed image 711 on the display surface 121 as the photographed image 711 including the image of the user A. In the similar manner, the controller 100 specifies, from the plurality of photographed images 711 in the storage 103, the photographed image 711 including the face image included in the user specifying information 810B, and displays the specified photographed image 711 on the display surface 121 as the photographed image 711 including the image of the user B. If the user having the fingerprint detected by the fingerprint sensor 200 is the user A, it is also applicable that, on the display surface 121, the photographed image relating to the user A is displayed and the photographed image relating to the user B is not displayed. If the user having the fingerprint detected by the fingerprint sensor 200 is the user B, it is also applicable that, on the display surface 121, the photographed image relating to the user B is displayed and the photographed image relating to the user A is not displayed.

The controller 100 may change the processing in accordance with a type of the finger, which touches the lock display object and has the fingerprint detected in the fingerprint sensor 200, of the user. One example of the operation of the electronic apparatus 1 in this case is described hereinafter. In the description hereinafter, the storage 103 stores, for example, a reference feature point indicating a feature of a fingerprint of a thumb of the user (referred to as “the reference feature point of the thumb” hereinafter) and a reference feature point indicating a feature of a fingerprint of an index finger of the user (referred to as “the reference feature point of the index finger” hereinafter).

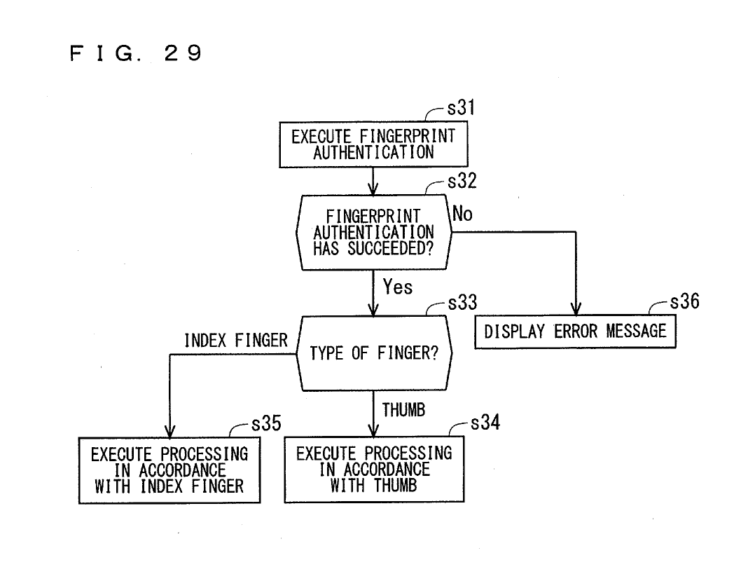

FIG. 29 is a flow chart showing one example of an operation of the electronic apparatus 1. If a predetermined operation is performed on the lock display object with the object, the controller 100 performs the fingerprint authentication based on the fingerprint detection result corresponding to the finger in the fingerprint sensor 200 in Step s31. Next, in Step s32, the controller 100 determines whether or not the fingerprint authentication in Step s31 has succeeded. If it is determined that the fingerprint authentication has failed in Step s32, the controller 100 displays the error message on the display surface 121 in Step s36. It is not necessary to execute Step s36.

In the meanwhile, if it is determined that the fingerprint authentication has succeeded in Step s32, the controller 100 specifies the type of the finger touching the lock display object in Step s33. If the type of the finger touching the lock display object is the thumb, the controller 100 executes the processing in accordance with the thumb in Step s34. If the feature point extracted from the fingerprint image indicating the fingerprint detected by the fingerprint sensor 200 is similar to the reference feature point of the thumb, the controller 100 determines that the type of the finger touching the lock display object is the thumb. If the type of the finger touching the lock display object is the index finger, the controller 100 executes the processing in accordance with the index finger in Step s35. If the feature point extracted from the fingerprint image indicating the fingerprint detected by the fingerprint sensor 200 is similar to the reference feature point of the index finger, the controller 100 determines that the type of the finger touching the lock display object is the index finger. The operation of one example shown in FIG. 29 is described in further detail with a specific example of the lock display object hereinafter.

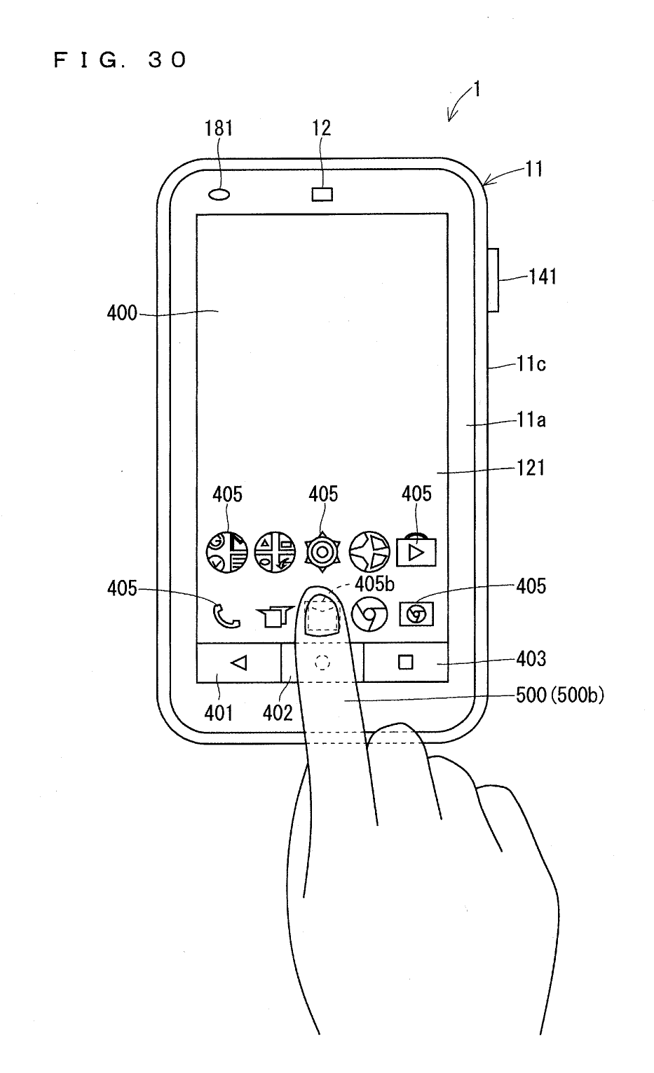

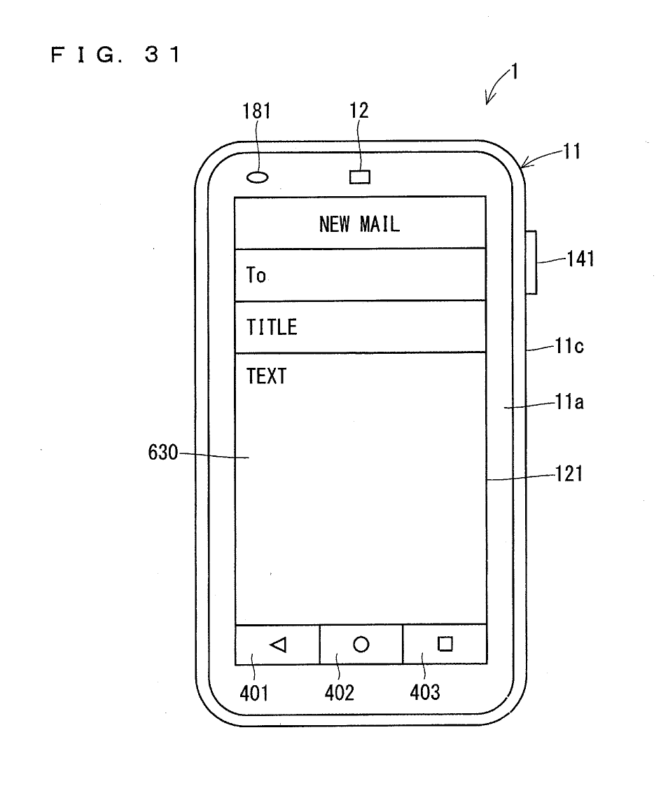

For example, if the tap operation is performed on the icon 405b, corresponding to the mail application, on which the processing lock setting is performed, the controller 100 performs the fingerprint authentication (Step s31). If the fingerprint authentication succeeds (YES in Step s32) and the finger touching the icon 405b is the thumb 500a as shown in FIG. 19 (the thumb is specified in Step s33), the controller 100 executes the mail application, and displays the list of the received mails on the display surface 121 in the manner similar to FIG. 20, for example (Step s34). If the fingerprint authentication succeeds (YES in Step s32) and the finger touching the icon 405b is the index finger 500b as shown in FIG. 30 (the index finger is specified in Step s33), the controller 100 executes the mail application, and displays a creation screen 630 for creating a new mail on the display surface 121 as shown in FIG. 31, for example (Step s35). If the fingerprint authentication fails (NO in Step s32), the controller 100 does not execute the mail application but displays the notification screen 410 including the error message 410a on the display surface 121 (Step s36). If the fingerprint authentication succeeds and the finger touching the icon 405b is a middle finger, the controller 100 may execute the mail application, and display a list of sent mails, for example.

The controller 100 may change the processing in accordance with a type of the finger, which has the fingerprint detected in the fingerprint sensor 200 and touches the photographed image on which the processing lock setting has been performed, of the user. In this case, if the long tap operation is performed with the finger on the photographed image on which the processing lock setting is performed, for example, the controller 100 performs the fingerprint authentication. If the fingerprint authentication succeeds and the finger touching the photographed image is the thumb, the controller 100 deletes, from the storage 103, the photographed image on which the long tap operation has been performed, for example. If the fingerprint authentication succeeds and the finger touching the photographed image is the index finger, the controller 100 displays, on the display surface 121, an edit screen for editing the photographed image on which the long tap operation has been performed, for example. Then, if the fingerprint authentication has failed, the controller 100 displays the notification screen 705 including the error message 705a on the display surface 121 as shown in FIG. 23 described above.

As described above, if the controller 100 changes the processing in accordance with the finger touching the display object on which the processing lock setting is performed, the processing executed by the electronic apparatus 1 changes in accordance with the user touching the display object or the type of the finger touching the display object. Thus, the operability of the electronic apparatus 1 is improved. The operation example of the electronic apparatus 1 when the controller 100 changes the processing in accordance with the finger touching the lock display object is not limited to the example described above.

Although the electronic apparatus 1 is a mobile phone, such as a smartphone, in the above-mentioned examples, the electronic apparatus 1 may be other types of electronic apparatuses. The electronic apparatus 1 may be a tablet terminal, a personal computer, and a wearable apparatus, for example. The wearable apparatus used as the electronic apparatus 1 may be an apparatus wearable on the wrist, such as a wristband apparatus and a wristwatch apparatus, an apparatus wearable on the head, such as a headband apparatus and an eyeglasses apparatus, and an apparatus wearable on the body, such as a clothing apparatus.

As described above, in the case where the electronic apparatus 1 can specify that the display surface 121 is touched by the object other than the finger of the person based on the output signal from the sensor 210, it is applicable that if the electronic apparatus 1 specifies that the operation detected by the touch panel 130 is an operation of the object other than the finger of the person touching the display surface 121, the electronic apparatus 1 does not execute a part or all of the control corresponding to the operation detected by the touch panel 130. The operation detected by the tough panel 130 includes the tap operation and the long tap operation performed on the display surface 121.

While the electronic apparatus 1 has been described above in detail, the above description is in all aspects illustrative and not restrictive. The various examples described above can be implemented in combination as long as they are not mutually inconsistent. It is understood that numerous examples which have not been exemplified can be devised without departing from the scope of the present disclosure.

What is claimed is:

1. An electronic apparatus, comprising:
a display surface;
a fingerprint sensor configured to detect a fingerprint of a finger touching the display surface; and
at least one processor configured to control a display of the display surface and perform a fingerprint authentication based on a fingerprint detection result in the fingerprint sensor, wherein
the at least one processor executes first processing if the display surface, which is in a non-display state, is touched with a first finger, the first processing comprising changing a state of the display surface to a display state and performing a first fingerprint authentication based on the fingerprint detection result corresponding to the first finger.

2. The electronic apparatus according to claim 1, further comprising
a sensor configured to detect a pressing force of the first finger on the display surface, wherein
the controller determines whether or not to execute the first processing in accordance with the pressing force detected by the sensor.

3. The electronic apparatus according to claim 1, wherein
the at least one processor displays a first display object in a position touched with the first finger in the display surface in the first processing.

4. The electronic apparatus according to claim 1, wherein
in a case where a second display object being displayed on the display surface is touched with a second finger, the at least one processor performs a second fingerprint authentication based on the fingerprint detection result corresponding to the second finger, and performs second processing relating to the second display object if the second fingerprint authentication succeeds and does not execute the second processing if the second fingerprint authentication fails.

5. The electronic apparatus according to claim 4, wherein
in a case where the second display object being displayed on the display surface is touched with a third finger different from the second finger, the at least one processor performs a third fingerprint authentication based on the fingerprint detection result corresponding to the third finger, and performs third processing, different from the second processing, relating to the second display object if the third fingerprint authentication succeeds and does not execute the third processing if the third fingerprint authentication fails.

6. The electronic apparatus according to claim 4, wherein
the second display object includes at least one of an icon for instructing the electronic apparatus to execute an application program and a photographed image.

7. A control device for controlling the electronic apparatus, the electronic apparatus including the control device, a display surface and a fingerprint sensor detecting a fingerprint of a finger touching the display surface, wherein
the control device changes a state of the display surface to a display state and performs a fingerprint authentication based on a fingerprint detection result corresponding to a finger in the fingerprint sensor if the display surface, which is in a non-display state, is touched with the finger.

8. A non-transitory computer readable storage medium that stores a control program, wherein
the control program controls an electronic apparatus including a display surface and a fingerprint sensor detecting a fingerprint of a finger touching the display surface, and
the control program makes the electronic apparatus execute processing of changing a state of the display surface to a display state and performing a fingerprint authentication based on a fingerprint detection result corresponding to a finger in the fingerprint sensor if the display surface, which is in a non-display state, is touched with the finger.
